(19) United States
(12) Patent Application Publication
(10) Pub. No.: US 2015/0095988 A1
(43) Pub. Date: Apr. 2, 2015

(54) INFORMATION PROCESSING DEVICE AND INFORMATION PROCESSING METHOD

(71) Applicant: Satoru Hirakata, Kanagawa (JP)

(72) Inventor: Satoru Hirakata, Kanagawa (JP)

(73) Assignee: RICOH COMPANY, LTD., Tokyo (JP)

(21) Appl. No.: 14/385,793

(22) PCT Filed: Apr. 5, 2013
(86) PCT No.: PCT/JP2013/060998

§ 371 Date: Sep. 17, 2014

(30) Foreign Application Priority Data
Apr. 10, 2012 (JP) 2012-089359
Mar. 11, 2013 (JP) 2013-048497

(51) Int. Cl. H04L 29/06; G06F 17/30

(52) U.S. Cl. CPC H04L 63/08; G06F 17/30958
USPC 726/4; 707/800

(57) ABSTRACT

An information processing device includes a storage area creation unit that creates a storage area containing a search condition for searching for data items in response to an input operation, a search unit that searches for, when the storage area containing the search condition is created, data items which match the search condition contained in the storage area from among data items stored in a database, a link information creation unit that creates link information for accessing the matching data items searched for by the search unit, and an arranging unit that arranges the link information created by the link information creation unit into the created storage area.

### TECHNICAL FIELD

The present invention relates to information processing devices, such as a document managing server, including a communication unit to communicate with a network device via a network, and a file storage unit to store files being accessed by the network device.

### BACKGROUND ART

With the widespread use of information technology (IT) of business operations, the number of data items (or electronic data) that are dealt with by individual persons and the number of kinds thereof are increasing more and more. Such data may be stored in a PC (personal computer) used by each individual person. However, from viewpoints of data security and maintenance, the data items dealt with by the individuals are often stored in a NAS (network-attached storage) or a file server (which will be referred to as a network storage device) rather than in the PCs used by the individuals.

In a case where many data items are stored in a network storage device, it is preferred that folders are created according to the kinds of the data items and the data items are arranged in the folders in an appropriate manner. If the data items are arranged in the folders of the network storage device in an appropriate manner, a user can discover a desired data item promptly when conducting a search at a later time. However, most users have little time to arrange various data items in the corresponding folders appropriately. If the data items are stored in the folders without arranging the data items appropriately, the user has to spend much time and effort to discover a desired data item.

Conventionally, a method of arranging document files is proposed. For example, Japanese Laid-Open Patent Publication No. 2006-048521 discloses a document retrieval device. In this document retrieval device, folders must be set up in a hierarchical structure according to a user definition, and document files to be arranged in each of the folders are determined by searching a document database using document retrieval conditions. When an indication of the hierarchical folder structure is displayed in a way that allows browsing of each folder, the name of each of the folders is automatically displayed with the corresponding document retrieval conditions.

### DISCLOSURE OF THE INVENTION

### Problems to be Solved by the Invention

In a case of the document retrieval device of Japanese Laid-Open Patent Publication No. 2006-048521 there is a problem in that a user has to define the hierarchical folder structure before using the document retrieval device. The user is not allowed to use the document retrieval device until the definition of the folder structure is finished. If the user has adequate time, the user can define the folder structure. However, most users have little time to define the hierarchical folder structure. Further, once the folder structure is set up according to the user definition, it is difficult to change the folder structure immediately.

Although there are many cases in which users desire to change the folder structure at a later time, in the case of the document retrieval device of Japanese Laid-Open Patent Publication No. 2006-048521, it is difficult to change the folder structure immediately. Hence, it is difficult to configure the document retrieval device of Japanese Laid-Open Patent Publication No. 2006-048521 to match the user's need for arranging or categorizing the document files in the folders immediately.

### DISCLOSURE OF THE INVENTION

In one aspect, the present invention provides an information processing device which is capable of arranging data items in folders with simple operations.

In one embodiment, the present invention provides an information processing device including a processing unit, the processing unit including: a storage area creation unit configured to create a storage area containing a search condition for searching for data items in response to an input operation; a search unit configured to search for, when the storage area containing the search condition is created, data items which match the search condition contained in the storage area from among data items stored in a database; a link information creation unit configured to create link information for accessing the matching data items searched for by the search unit; and an arranging unit configured to arrange the link information created by the link information creation unit into the created storage area.

### BRIEF DESCRIPTION OF THE DRAWINGS

FIG. 1 is a diagram for explaining operations of a document managing device of an embodiment of the invention.

FIG. 2 is a diagram showing a network system including the document managing device of the present embodiment.

FIG. 3 is a block diagram showing the hardware composition of the document managing device of the present embodiment.

FIG. 4 is a diagram for explaining a protocol stack by which an information processing device communicates with the document managing device.

FIG. 5 is a block diagram showing the functional composition of the document managing device of the present embodiment.

FIG. 6 is a diagram showing an example of user information.

FIG. 7 is a diagram showing an example of folder management information.

FIG. 8 is a diagram showing an example of a folder structure.

FIG. 9 is a flowchart for explaining a search/arrange process in which the document managing device searches and arranges a data file.

FIG. 10 is a flowchart for explaining a categorizing process in the search/arrange process of FIG. 9.

FIG. 11 is a flowchart for explaining a data file monitor process in which the document managing device monitors creation, updating, and deletion of a data file.

FIG. 12 is a diagram for explaining a search/arrange operation of the document managing device.

FIG. 13 is a diagram for explaining a search/arrange operation of the document managing device.

FIG. 14 is a diagram for explaining a search/arrange operation of the document managing device by using two keywords.

FIG. 15 is a diagram for explaining an arranging operation of a document managing device of another embodiment of the invention to arrange data files in a hierarchical folder structure.

FIG. 16 is a diagram showing an example of folder management information of the present embodiment.

FIG. 17 is a diagram for explaining a hierarchical search/arrange operation by using a combination of folders.

FIG. 18 is a flowchart for explaining a search/arrange process performed by the document managing device of this embodiment.

FIG. 19 is a diagram for explaining a search/arrange operation of the document managing device using a time period.

FIG. 20 is a diagram for explaining a display indication of a status file.

FIG. 21 is a diagram for explaining a display screen including a color-based display indication of a search status.

FIG. 22 is a diagram showing a network system including a document managing device of another embodiment of the invention.

FIG. 23 is a diagram showing the hardware composition of an image forming device in the network system.

FIG. 24 is a sequence diagram for explaining a file receiving process in which the image forming device receives an original file from the document managing device.

FIG. 25 is a diagram showing an example of link information displayed on a display part of the image forming device.

FIG. 26 is a sequence diagram for explaining a file receiving process in which a mobile terminal receives an original file from the document managing device.

### MODE FOR CARRYING OUT THE INVENTION

A description will be given of embodiments of the invention with reference to the accompanying drawings.

### Embodiment 1

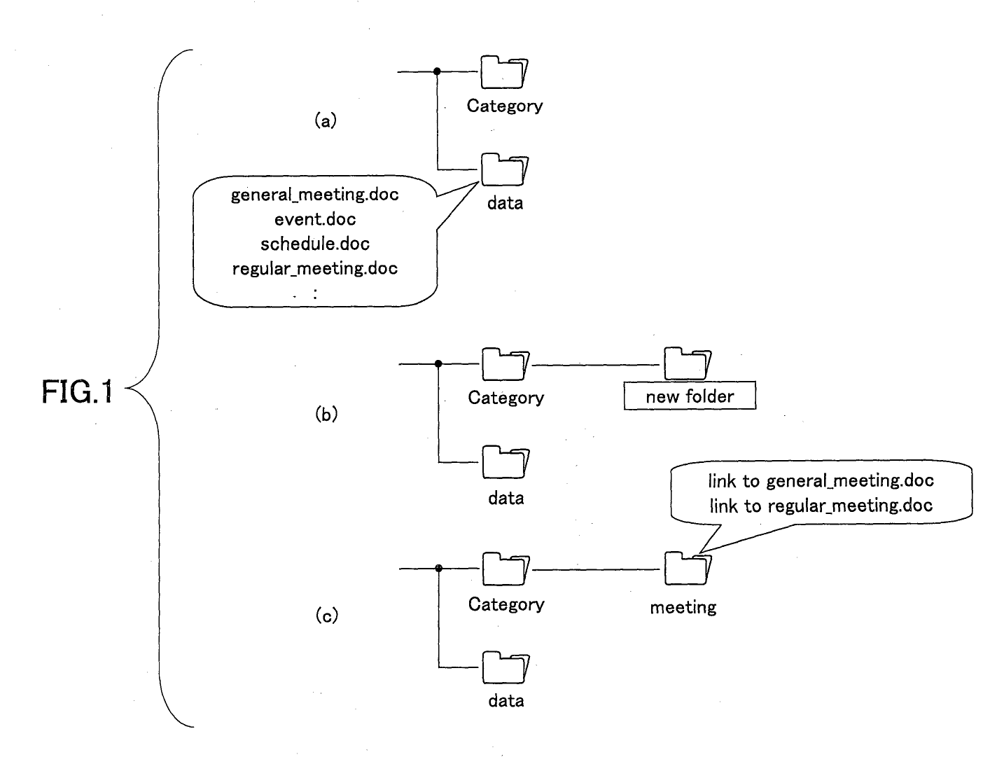

FIG. 1 is a diagram for explaining operations of a document managing device of an embodiment of the invention. In a state (a) of FIG. 1, the document managing device initially has two folders: a category folder and a data folder. Data items which are created daily and used as the objects of search and arrangement are stored in the data folder. For example, document files (including general_meeting.doc, event.doc, schedule.doc, regular_meeting.doc, etc.) are stored in the data folder. The category folder is a folder which is provided for searching for and arranging the data items in the data folder.

In a state (b) of FIG. 1, in order to search for or arrange the data items on the document managing device, a user creates a folder within the category folder as a lower-rank folder. A default folder name (“new folder” indicated in FIG. 1) is assigned to the created folder by the OS (operating system).

In a state (c) of FIG. 1, the user changes the default folder name of the created folder to a keyword that contains a data item of a searching object. For example, when searching for data items containing a keyword “meeting”, the user changes the default folder name of the created folder to “meeting”.

The document managing device searches for data items containing the keyword “meeting” in the data folder, and creates links to the discovered data items in the meeting folder with the folder name “meeting”. For example, when the data items “general_meeting.doc” and “regular_meeting.doc” are discovered in the data folder, the document managing device creates a link to the data item “general_meeting.doc” and a link to the data item “regular_meeting.doc” in the meeting folder.

In this manner, the document managing device of this embodiment creates a folder to have a folder name containing a search keyword, and searches for data items in a data folder using the folder name of the created folder. In the example of FIG. 1, the file names of the data items in the data folder are used as the searching object, for the purpose of explanation. Alternatively, documents containing a search keyword in a data folder may be used as the searching object.

Conventionally, a method of storing the discovered data items as search results in a folder is known. However, the search results stored in the folder change for each search and maintaining the previous search results, obtained upon a particular search, to remain unchanged in the folder has been impossible. In contrast, in the document managing device of this embodiment, search results are stored in a folder which is created by a user, and the search results remain unchanged in the folder unless the user performs a deleting operation to delete the folder. Hence, when the user creates a folder with a folder name containing another keyword and conducts another search, the user is allowed to refer to the previous search results in a unitary manner. Maintaining the search results of data items categorized according to arbitrary keywords in a searchable state is exactly the same as arranging the data items in folders.

As described above, with simple operations of creating folders, the user can search for and arrange data items in the folders. For example, if folders are created according to the kinds of data items, various data items can be arranged in the folders with simple operations. In a case where the user desires to change the keyword used to arrange the data items, the corresponding folder is deleted and a new folder is created with a folder name containing an arbitrary keyword, and the results of arrangement of the data items can be changed. In this manner, the document managing device of this embodiment can search for and arrange the data items with simple operations.

Since data items are managed on a data file basis, data items used as searching objects according to the present embodiment will be called data files in the following. Such data files may include text files, data files (*.doc, *.xls, *.ppt, *.pdf, *.html) created by various kinds of application programs, image data files (*.jpeg, *.ttf, *.bmp), video data files (*.avi, *.mpg, *.mov), audio data files (*.mp3, *.wav, *.wma), etc. The data files according to the present embodiment may include a data file created in the form of a file as the searching object by an arbitrary application program. In addition, computer-executable files (*.exe, *.dll) are also the data files according to the present embodiment.

There are three kinds of folders which are used according to the present embodiment as in the following.

(i) folders for data file storage (the “data” folder in FIG. 1)

(ii) folders for searching/arranging use (the “category” folder in FIG. 1)

(iii) folders for link information storage (the “meeting” folder of FIG. 1)

The user can use the document managing device of this embodiment by grasping the differences in the attributes of these folders from the folder names. In a certain kind of the OS, folders may be called directories. In such a case, the folder name according to the present embodiment may be replaced by a directory name. Any other name different from a folder or a directory, if it refers to a storage area where a file is stored, may be applicable to the present embodiment.

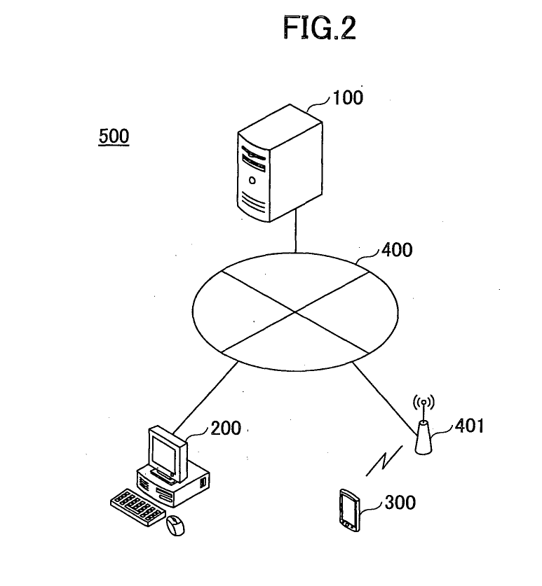

FIG. 2 is a diagram showing a network system 500 which includes a document managing device 100 of the present embodiment. As shown in FIG. 2, in the network system 500, the document managing device 100, a mobile terminal 300, and an information processing apparatus 200 are interconnected by a network 400. The network 400 may be any of a LAN (local area network), a VLAN (virtual LAN), the Internet to which plural LANs are connected by a router or Layer 3 switching, etc. Alternatively, plural document managing devices 100 and plural mobile terminals 300 or plural information processing apparatuses 200 may be arranged in a one-to-one correspondence. The network system 500 may include partially or fully wireless connections, such as wireless LANs or mobile phones, in wireless communication networks provided by common carriers.

The document managing device 100 receives a request of data file registration and a request of operation of search and arrangement from the information processing apparatus 200 or the mobile terminal 300 via the network 400. For example, the document managing device 100 is constituted by a file server or a NAS (network-attached storage). Alternatively, the document managing device 100 may be constituted by a simple server, a network device, etc.

Further, the document managing device 100 may be constituted by a stand-alone PC (personal computer) which is arranged to have a document managing function. In other words, the document managing device 100 may not be connected to the network 400, and the user may operate the document managing device 100 directly.

The mobile terminal 300 may be constituted by a portable-type information processing device, such as a smart phone, a tablet, a mobile phone, a PDA (personal digital assistant), a notebook PC, or a laptop PC. The mobile terminal 300 is provided with a communication adapter and able to communicate with the network 400 by radio.

The mobile terminal 300 communicates with the document managing device 100 via an access point or a base station 401 provided by a common carrier using a radio communication device which conforms with any of the standards, such as wireless LAN, WiMAX, LTE (long term evolution), HSDPA (high-speed downlink packet access), CDMA (code division multiple Access), GSM® (global system for mobile communications), etc. When the mobile terminal 300 is connected to the base station 401, it connects with the network 400 via the server and the gateway of a communication enterprise.

For example, the information processing apparatus 200 is constituted by a desktop PC or a notebook PC. The OS of the information processing apparatus 200 may be any of WINDOWS®, LINUX®, UNIX®, etc.

Each of the mobile terminal 300 and the information processing apparatus 200 in the network system 500 is capable of searching for and arranging the data files of the document managing device 100 similarly. In the following, a case in which the information processing apparatus 200 communicates with the document managing device 100 will be described as an example.

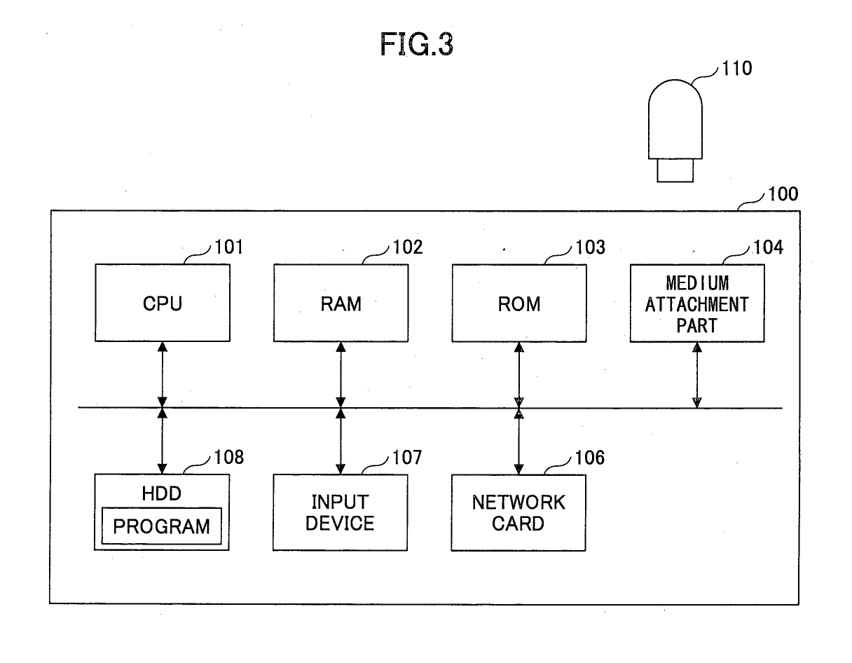

FIG. 3 is a block diagram showing the hardware composition of the document managing device 100. As shown in FIG. 3, the document managing device 100 includes a CPU (central processing unit) 101, a RAM (random access memory) 102, a ROM (read-only memory) 103, a medium attachment part 104, a network card 106, an input device 107, and an HDD (hard disk drive) 108, which are interconnected by a bus.

The CPU 101 carries out various functions of the document managing device 100 by reading the OS and one or more programs from the HDD 108 and executing the program. The CPU 101 generally controls various processes which are performed by the document managing device 100.

The RAM 102 provides the work memory (main memory) which temporarily stores the data needed for the CPU 101 to execute the program. The ROM 103 stores a boot program to initiate the BIOS (basic input output system) and the OS, the configuration files, etc.

A recording medium 110 can be detachably attached to the medium attachment part 104, and the program stored in the medium 110 is read and stored in the HDD 108 through the medium attachment part 104. The medium attachment part 104 can also write the data stored in the HDD 108 to the medium 110. The medium 110 may be any of a USB memory, an SD memory card, a DVD-ROM, a CD-ROM, etc.

The input device 107 may include a keyboard, a touchpad, a mouse, etc., and receives various instructions from a user or an administrator of the document managing device 100.

The HDD 108 may be constituted by a non-volatile memory, such as SSD (solid state drive). The HDD 108 stores the OS, the programs, and various kinds of files. Data files are usually stored in the HDD 108. Alternatively, data files may be stored in an external HDD connected to the document managing device 100.

The network card 106 is a communication device for connecting the document managing device 100 to the network 400. For example, the network card 106 may be constituted by an Ethernet® card.

The programs may be stored in the medium 210, or downloaded from a non-illustrated server into the document managing device 100. The programs being distributed may be in a compressed form or in an executable form for installation.

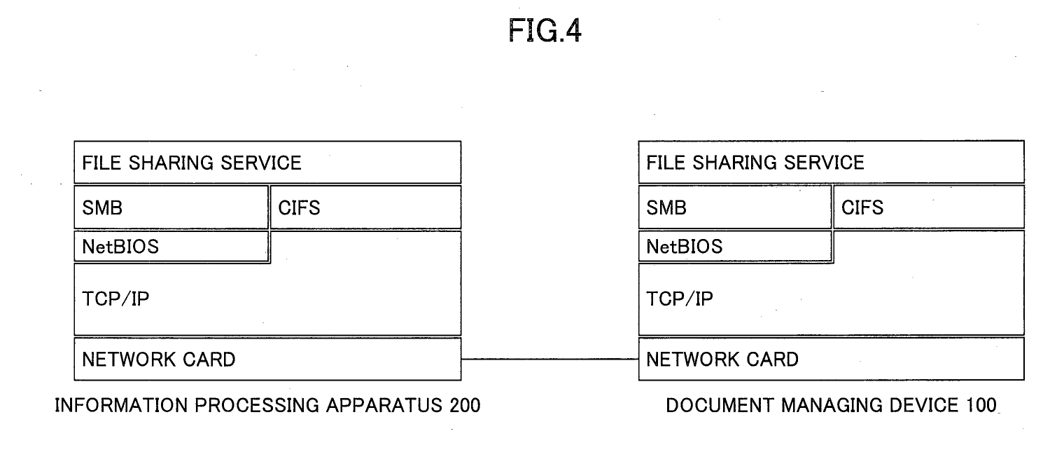

FIG. 4 is a diagram for explaining a protocol stack by which the information processing apparatus 200 communicates with the document managing device 100. In the present embodiment, a user operates the information processing apparatus 200 to search for and arrange the data files of the document managing device 100. Using the framework of file sharing is convenient for the present embodiment. As a protocol suitable for file sharing, the SMB (server message block) and the CIFS (common Internet file system) are known. The CIFS is the extended SMB protocol and provides almost the same functions as the SMB. The CIFS operates on the TCP/IP, and the SMB differs from the CIFS in that the SMB uses the NetBIOS when operating on the TCP/IP. In the following, the difference between the SMB and the CIFS will be disregarded.

The TCP establishes a session with a communication partner and controls a communication process. The TCP disassembles communication data into packets and passes the packets to the IP protocol. The TCP receives the packets received by the network card via the IP protocol, and reconstructs the communication data from the received packets. The IP protocol performs routing which allows the packets to reach the communication partner based on the IP address of the communication partner.

The network card constructs a physical communication layer with a communication partner, performs voltage amplification and signal waveform fabrication, etc., and performs communication congestion control. The network card extracts data from a signal waveform and stores the data in a frame. The frame is identified by the network card with a unique MAC (media access control) address.

The file sharing service is a program which carries out the file sharing by using the SMB or CIFS protocol. In many cases, the TCP/IP, the SMB, the CIFS, and the file sharing service are included in the OS and provided in the information processing apparatus 200.

The SMB and CIFS protocols are request-response type protocols, and the information processing apparatus 200 and the document managing device 100 transmit and receive the data blocks of the same form and carry out the file sharing. Even if a user performs a single operation of folder creation, a set of communication data is transmitted and received. The processes which the file-sharing service can request the device of a communication partner to perform are specified as command codes. For example, a folder creation process is specified as command code “0x00” (SMB_COM_CREATE_DIRECTORY) and a folder deletion process is specified as command code “0x01” (SMB_COM_DELETE_DIRECTORY).

In addition, the file sharing may be carried out with a protocol called WebDAV (web-based distributed authoring and versioning) besides the SMB or the CIFS. The WebDAV is the extended HTTP1.1 protocol in which methods, headers, etc. are added to the HTTP1.1 protocol. The communication procedure of the WebDAV is also the same as that of the HTTP (hypertext transfer protocol) in which the server returns a response to a request from the client. The WebDAV does not depend on a file system, and if a conforming browser is provided, the WebDAV is usable regardless of the OS.

In the HTTP, the client is allowed to view a file only. In the WebDAV, the client is allowed to edit, add, and delete a data file on a network in the same procedure as the HTTP.

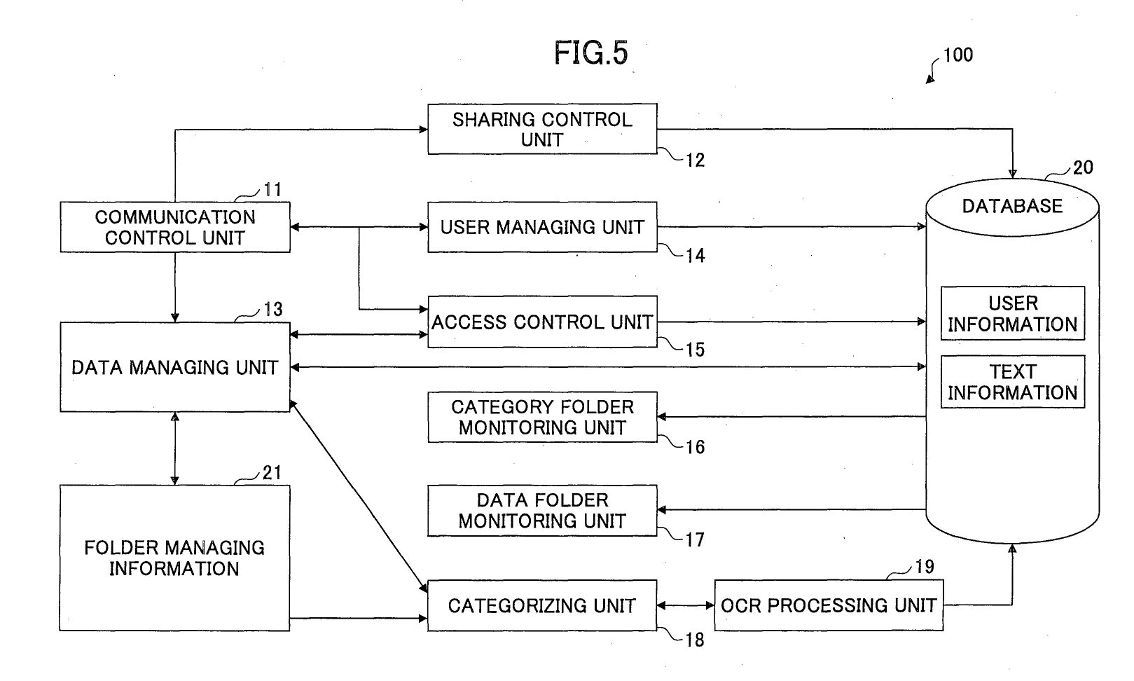

FIG. 5 is a block diagram showing the functional composition of the document managing device 100. As shown in FIG. 5, the document managing device 100 generally includes a communication control unit 11, a sharing control unit 12, a data managing unit 13, a user managing unit 14, an access control unit 15, a category folder monitoring unit 16, a data folder monitoring unit 17, a categorizing unit 18, and an OCR processing unit 19. These functions of the document managing device 100 are carried out by the CPU 101 which executes the program in conjunction with the hardware resources of the document managing device 100.

The document managing device 100 includes a database 20. The database 20 is constituted by, for example, the HDD 108. The database 20 is a storage of the data files as substantial data. The database 20 stores text information indicating OCR results of the data files arranged by the document managing device 100, and user information indicating users who are allowed to access the document managing device 100, in addition to the data files. Alternatively, the database 20 may be constituted by the medium 110 attached to the document managing device 100.

The communication control unit 11 controls communications through the network 400 with an external device (which is, in this embodiment, the information processing apparatus 200 or the mobile terminal 300). For example, the communication control unit 11 is arranged to process the requests according to the SMB/CIFS protocol. The communication control unit 11 provides all or a part of the functions of the layers shown in FIG. 4.

By using the SMB/CIFS protocol, the folders and files of the document managing device 100 can be displayed on a display part of the information processing apparatus 200. The communication control unit 11 receives from the information processing apparatus 200 various kinds of access requests to the folders in the document managing device 100, and the access requests may include a folder creation request, a folder updating request, and a data file storage request, etc.

The sharing control unit 12 controls a storage region provided on the network 400 by the document managing device 100 and shared by the users. For example, the sharing control unit 12 is arranged so that shared folders may be defined on a group basis in the storage region, or user folders for the users may be defined in the storage region. The sharing control unit 12 manages the storage region such that the quantity of storage of the shared folders or the quantity of storage of the user folders does not exceed its corresponding maximum storage quantity.

When the communication control unit 11 receives a request for accessing a shared folder or a user folder from a user, the user managing unit 14 is caused to authenticate the user. The user managing unit 14 authenticates the user who attempts to access the shared folder or the user folder. The user managing unit 14 performs the user authentication based on the user information of the database 20.

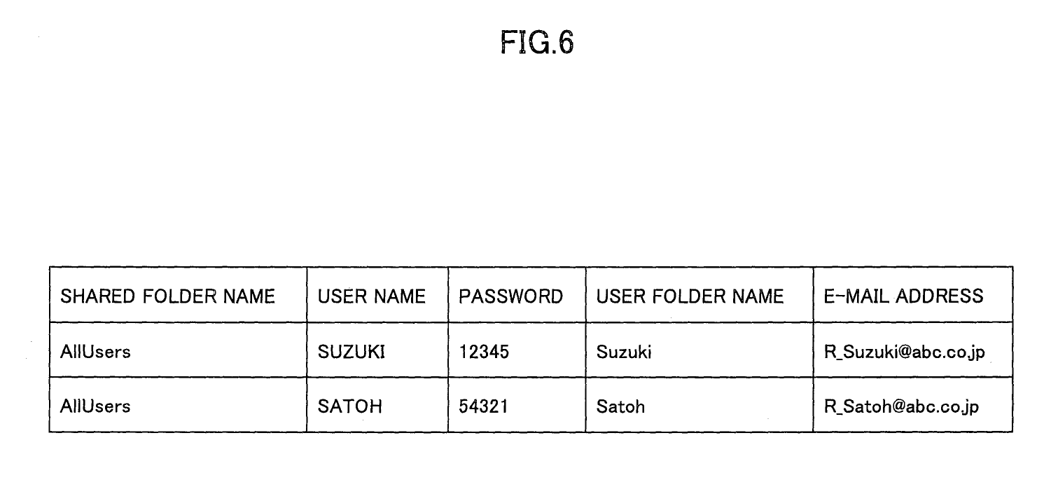

FIG. 6 shows an example of the user information. For example, the user information includes a “shared folder name”, a “user name”, a “password”, a “user folder name”, and an “e-mail address”. The “shared folder name” is a folder name of a shared folder which is shared and accessible by plural users. The “user folder name” is a folder name of a user folder dedicated for each user. Both shared folders and user folders are accessible only by the users who are authenticated by a given authentication process. Each user, even if authenticated, can access only his own user folder for exclusive use. The user name may be any kind of information that uniquely identifies the user, such as a user ID.

Referring back to FIG. 5, the user managing unit 14 determines whether a user is authenticated based on whether a pair of a “user name” and a “password” which are received from the information processing apparatus 200 is registered in the database 20. If the user is authenticated, the user can access the shared folder and his own user folder.

The access control unit 15 controls the access right of the user when attempting to access the data file in the document managing device 100. The access control unit 15 accesses the user information of the database 20 based on the user name of the authenticated user, and permits the user to access the data files in the shared folder and the user folder which are accessible by the user. The access control unit 15 notifies the data managing unit 13 of the permission of accessing the data files.

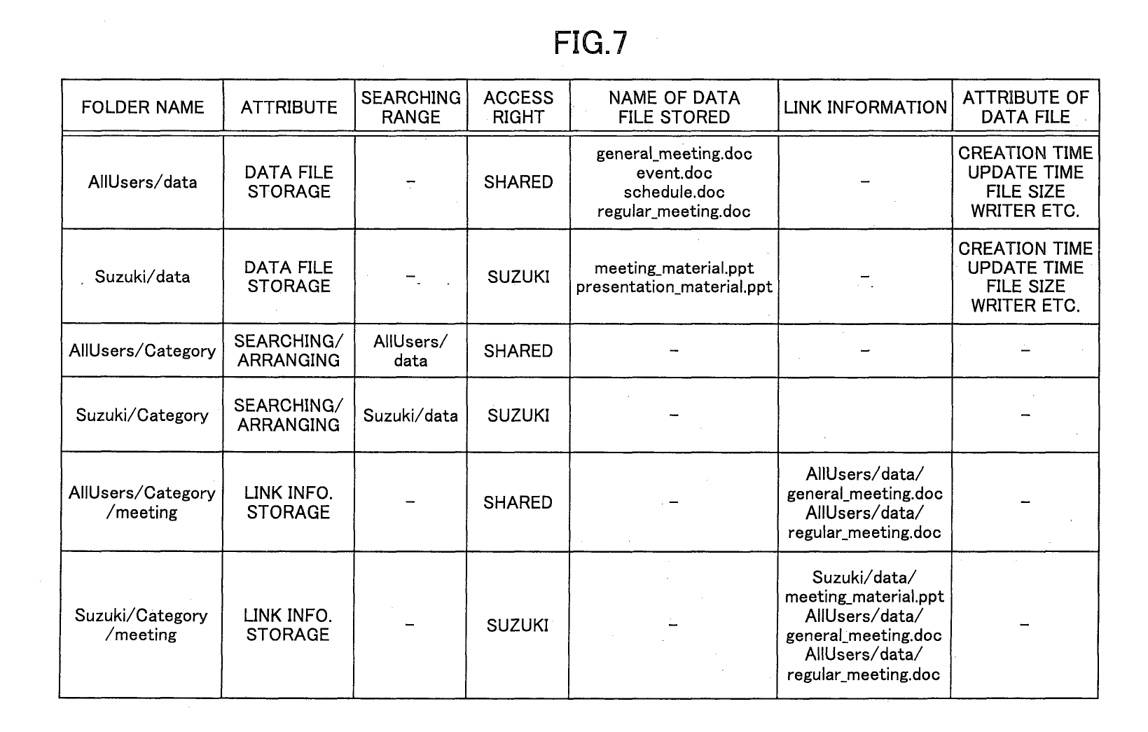

The data managing unit 13 manages the data files stored in the document managing device 100. FIG. 7 is a diagram showing an example of folder management information 21 which is managed by the data managing unit 13. For example, the folder management information 21 managed by the data managing unit 13 includes the following items:

the attribute of each folder (a data file storage folder, a folder for searching/arranging use, a folder for link information storage, etc.);

the data files stored in each folder (a data file name, a date and time of creation, an update date, a file size, a writer, etc.);

the link information with respect to the data files stored in each folder;

the searching range of data files; and

the access right to the folder.

Referring back to FIG. 5, the category folder monitoring unit 16 monitors creation, deletion, etc. of a category folder and notifies the data managing unit 13 of the monitoring result. There are some methods of monitoring creation and deletion of a folder, including a method of performing a polling process periodically, a method of receiving a call-back from a file system, etc.

The data folder monitoring unit 17 monitors creation, updating, deletion, etc. of a data file in a shared folder or a user folder and notifies the data managing unit 13 of the monitoring result. There are some methods of monitoring creation and deletion of a folder, including a method of performing a polling process periodically, a method of receiving a call-back from a file system, etc.

The data managing unit 13 updates the folder management information 21 based on the notifications from the category folder monitoring unit 16 and the data folder monitoring unit 17, and sends a categorizing process request to the categorizing unit 18. The attribute of the newly created folder is determined based on the location where the folder is created. For example, the attribute of a folder created at a lower-rank location of a searching/arranging folder is a folder for link information storage, and the attribute of a folder created at a lower-rank location of a data file storage folder is a data file storage folder.

The categorizing unit 18 performs a categorizing process when creation, updating or deletion of a folder or a data file is monitored. By performing the categorizing process, the search and arrangement is performed.

A. A Search/Arrange Operation Performed by the Document Managing Device 100 Including the Categorizing Unit 18 when a Folder is Created, Updated or Deleted Will be Described.

When a folder for link information storage is newly created in a searching/arranging folder, the categorizing unit 18 searches for the data files in the data file storage folder by using a folder name of the newly created folder, and notifies the data managing unit 13 of the search results. The searching range at this time is specified in the folder management information 21.

The data managing unit 13 creates the link information with respect to the data files in the data file storage folder, and stores the link information in the newly created link information storage folder.

The categorizing unit 18 searches for the following items as the searching object:

(i) the file name of a data file;
(ii) the full text of a data file; and
(iii) in a case of image data, the full text of OCR results obtained by performing an OCR process on the image data.

Specifically, when a character string that is the same as the folder name is contained in the file name or the data file, it is determined that the data file is hit. If the folder name is set to an extension of the file name of each of the data files being searched, all the data files with the file name having the extension are hit.

When a user changes the folder name of the link information storage folder in which the search results are already stored, the data managing unit 13 updates the folder name and the link information of the folder management information 21. Then, the process that is the same as in the case where the link information storage folder is newly created is performed.

When a user deletes the link information storage folder in which the search results are already stored, the data managing unit 13 deletes the record of the deleted folder in the folder management information 21.

B. A Search/Arrange Operation Performed by the Document Managing Device 100 Including the Categorizing Unit 18 when a Data File is Created, Updated or Deleted Will be Described.

When a data file is newly created in a data file storage folder, the categorizing unit 18 sets the created data file to a new searching object by using a folder name of the data file storage folder. For example, when a link information storage folder “meeting” is already created and a file “meeting.doc” is newly created in a data file storage folder, the categorizing unit 18 determines that the file “meeting.doc” is hit with respect to the “meeting” folder. In this case, the data managing unit 13 creates the link information to the file “meeting.doc” in the link information storage folder “meeting”. The categorizing unit 18 determines whether the newly created data file is hit with respect to the folder name of each of the folders for link information storage. Hence, even if a data file is newly created, the user can arrange the data file without performing additional operations other than an operation to copy the data file from the information processing apparatus 200 to the document managing device 100.

When a user changes the file name or file content of a data file stored in a data file storage folder, the categorizing unit 18 performs the process that is the same as in the case where the data file is newly created. When the file name is hit due to the change of the file name or the file content, the link information storage folder in which the link information is stored may be changed. On the other hand, when the full text is hit and the file name is changed, the link information storage folder in which the link information is stored remains unchanged. The data managing unit 13 updates the link information of the folder management information 21 according to the search results.

When a user deletes the data file stored in the data file storage folder, the data managing unit 13 deletes the link information with respect to the deleted data file in each folder for link information storage, and updates the folder management information 21. Hence, it is possible to prevent the link information with respect to the deleted data file from remaining in the folder management information 21.

The OCR processing unit 19 performs an OCR process on a data file when an OCR process request is received from the categorizing unit 18. The result of the OCR process (namely, text information) is associated with the file name of the data file and stored in the database 20. When the data file on which the OCR process is performed is updated, the text information is also updated.

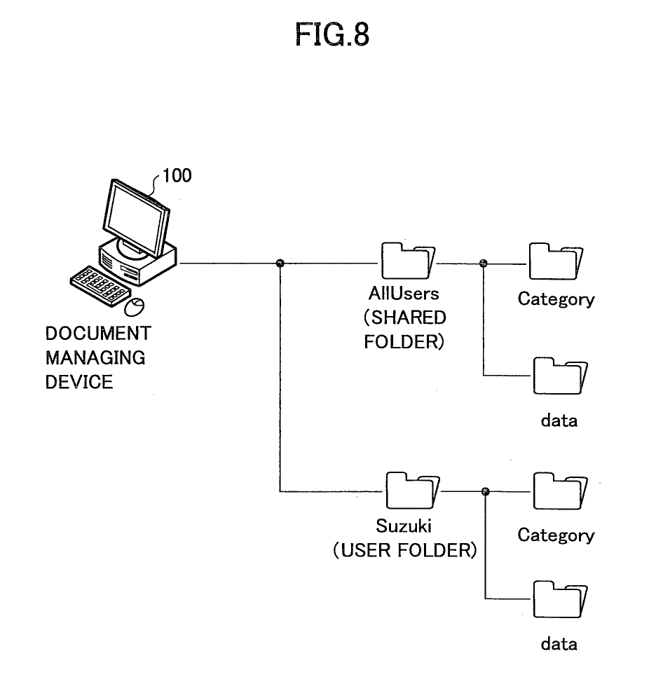

FIG. 8 is a diagram for explaining an example of the folder structure. As shown in FIG. 8, the document managing device 100 has a shared folder which is accessible by all the users registered in the user information, and a user folder which is accessible by a particular user only. In the example of FIG. 8, an AllUsers folder is a shared folder and a Suzuki folder is one of user folders. A category folder and a data folder are provided at a lower rank position of the folder structure for each of the AllUsers folder and the Suzuki folder, respectively. The category folder is a searching/arranging folder and the data folder is a data file storage folder. A user may determine the searching/arranging folder or the data file storage folder based on a folder name of the corresponding folder.

Alternatively, the folder structure may be arranged so that no category folder is provided and a link information storage folder is created at a lower rank position of a data folder. However, a data file storage folder may be created at a lower rank position of a data folder, or a data file storage folder and a data file arrangement folder may be separately created so as to make the results of data file arrangement legible from a user.

In the present embodiment, the data files which the user desires to share with other users are stored in the AllUsers/data folder, and the data files which are accessible by the user solely are arranged in the Suzuki/data folder. Accordingly, without storing the data files in the information processing apparatus 200, accessing the data files on the network by the other users is restricted and accessing the data files on the network from the user at remote location where one has gone is possible.

When the user searches for or arranges the data files in the data folder, a new folder (a link information storage folder) is created at a lower-rank location of the AllUsers/category folder or the Suzuki/category folder.

When a link information storage folder is created at a lower-rank location of the AllUsers/category folder, the categorizing unit 18 confirms the “searching range” of the folder management information 21 and searches for the data files in the AllUsers/data folder. When a link information storage folder is created at a lower-rank location of the Suzuki/category folder, the categorizing unit 18 confirms the “searching range” of the folder management information 21 and searches for the data files in both the AllUsers/data folder and the Suzuki/data folder. In the latter case, the user is allowed to search for the data files in the two data folders by creating one link information storage folder. If accessing the searching range is permitted to another user of the same group, adjustment of the searching range is possible.

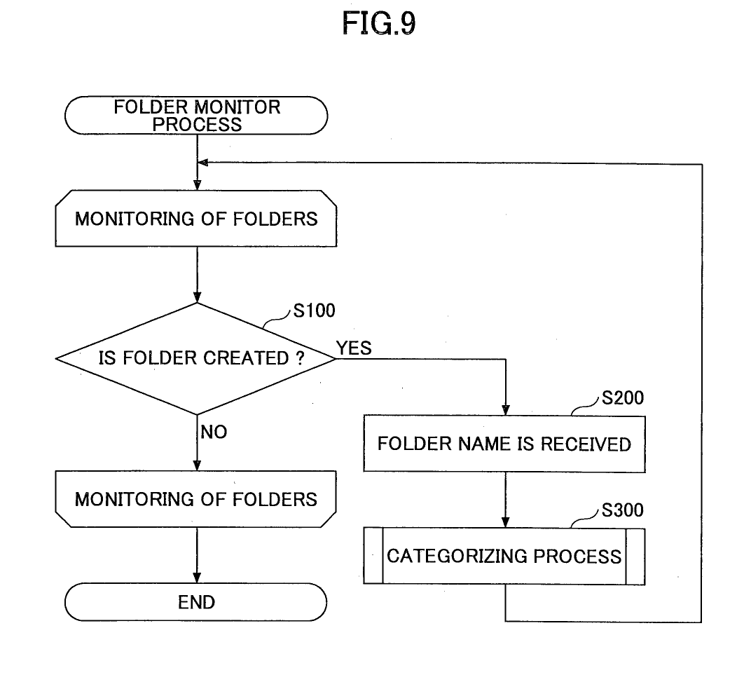

FIG. 9 is a flowchart for explaining a search/arrange process in which the document managing device 100 searches for and arranges a data file. Upon starting of the document managing device 100, the process of FIG. 9 is initiated.

The category folder monitoring unit 16 monitors the category folders. Based on the monitored result, the category folder monitoring unit 16 determines whether a folder is created at a lower-rank location of a searching/arranging folder (S100). The upper-rank folder of the newly created folder can be received from the file system. After the newly created folder is registered in the folder management information 21, the upper-rank folder of the newly created folder is easily identified by the folder management information 21. If the upper-rank folder is identified, whether the folder is a searching/arranging folder or not is registered in the folder management information 21.

When it is determined at the step S100 that the folder is created at the lower-rank location of the searching/arranging folder (Suzuki/category folder), the data managing unit 13 notifies the categorizing unit 18 of a folder name of the created folder and sends a categorizing process request to the categorizing unit 18 (S200).

The categorizing unit 18 confirms the searching range of the upper-rank folder (Suzuki/category folder) of the created folder based on the folder management information 21, and performs the search/arrange process on the data file storage folder by using the folder name as a keyword (S300).

After the search/arrange process is performed, the control of the document managing device 100 is returned to the monitoring of the category folders.

When it is determined at the step S100 that no folder is created at the lower-rank location of the searching/arranging folder, the control of the document managing device 100 is returned to the monitoring of the category folders. Upon power-down of the document managing device 100, the process of FIG. 9 is terminated.

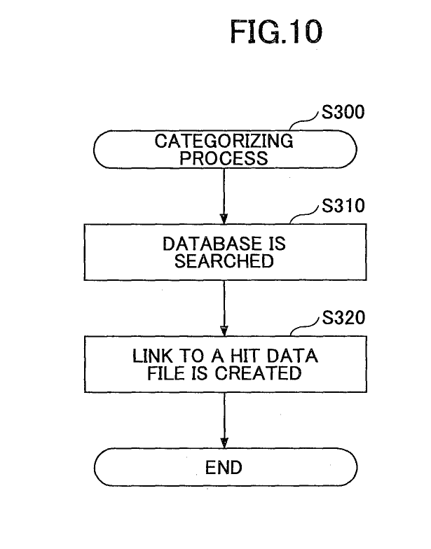

FIG. 10 is a flowchart for explaining the categorizing process in the search/arrange process of FIG. 9. The categorizing process in FIG. 10 is initiated when it is determined at the step S100 in FIG. 9 that the folder is created at the lower-rank location of the searching/arranging folder.

The categorizing unit 18 searches for the data files in the data folder by using the folder name of the link information storage folder as a keyword (S310). For example, when the link information storage folder is created in the AllUsers/category folder, the AllUsers/data folder is searched for. When the link information storage folder is created in the Suzuki/category folder, the Suzuki/data folder and the AllUsers/data folder are searched for.

Subsequently, the categorizing unit 18 creates the link information with respect to the hit data file, and arranges the created link information in the link information storage folder (S320).

After the link information is arranged in the link information storage folder, the categorizing process of FIG. 10 is terminated.

Next, a process performed when a data file is arranged in the data folder after the link information storage folder is created will be described.

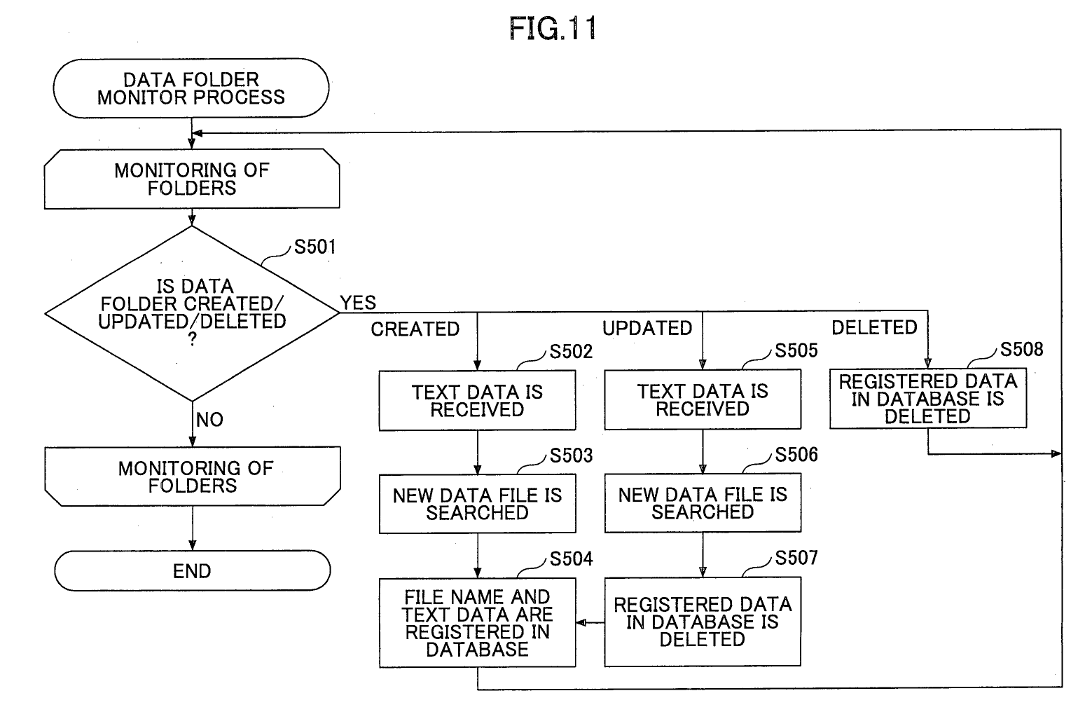

FIG. 11 is a flowchart for explaining a data file monitor process in which the document managing device 100 monitors creation, updating, and deletion of a data file. Upon starting of the document managing device 100, the data file monitor process of FIG. 11 is initiated. The processes of FIG. 9 and FIG. 11 may be performed in parallel. Alternatively, the process of FIG. 9 and the process of FIG. 11 may be repeated alternately.

The data folder monitoring unit 17 monitors the data files. The data folder monitoring unit 17 determines whether a change (creation, updating, deletion, etc.) of a data file stored at a lower-rank location of the data folder takes place (S501).

The Process of FIG. 11 Performed when a Data File is Newly Created Will be Described in the Following.

When a data file is newly created, the categorizing unit 18 receives text information from the data file (S502). If the data file contains image data, the OCR processing unit. 19 performs the OCR process on the image data.

The categorizing unit 18 searches the file name or the text information of the data file by using the folder name of the existing link information storage folder as a keyword. The categorizing unit 18 creates the link information if the folder name is hit (S503). The data managing unit 13 updates the folder management information 21.

When the OCR process is performed, the text information and the file name which are received from the data file are registered into the database 20 (S504).

The Process of FIG. 11 Performed when a Data File is Updated Will be Described in the Following.

When a data file is updated, the categorizing unit 18 receives text information from the data file similar to the case where the data file is newly created (S505). If the data file contains image data, the OCR processing unit 19 performs the OCR process on the image data.

The categorizing unit 18 searches for the file name or the text information of the updated data file by using the folder name of the existing link information storage folder as a keyword (S506).

When the OCR process is performed, the data managing unit 13 deletes the registered text information in the database 20 which is associated with the updated data file (S507). The data managing unit 13 newly registers the text information and the file name which are associated with each other in the database 20 (S504).

The Process of FIG. 11 Performed when a Data File is Deleted Will be Described in the Following.

When a data file is deleted, the data managing unit 13 deletes the link information of the data file in the folder management information 21 (S508). If the text information is registered, the data managing unit 13 deletes the text information in the database 20.

After the corresponding process required for creation, updating, and deletion of the data file is performed, the control of the document managing device 100 is returned to the monitoring of the data files.

When it is determined at the step S501 that change (creation, updating, deletion) of the data file does not take place, the control of the document managing device 100 is returned to the monitoring of the data files. After a predetermined time limit is reached, the data file monitor process of FIG. 11 is terminated.

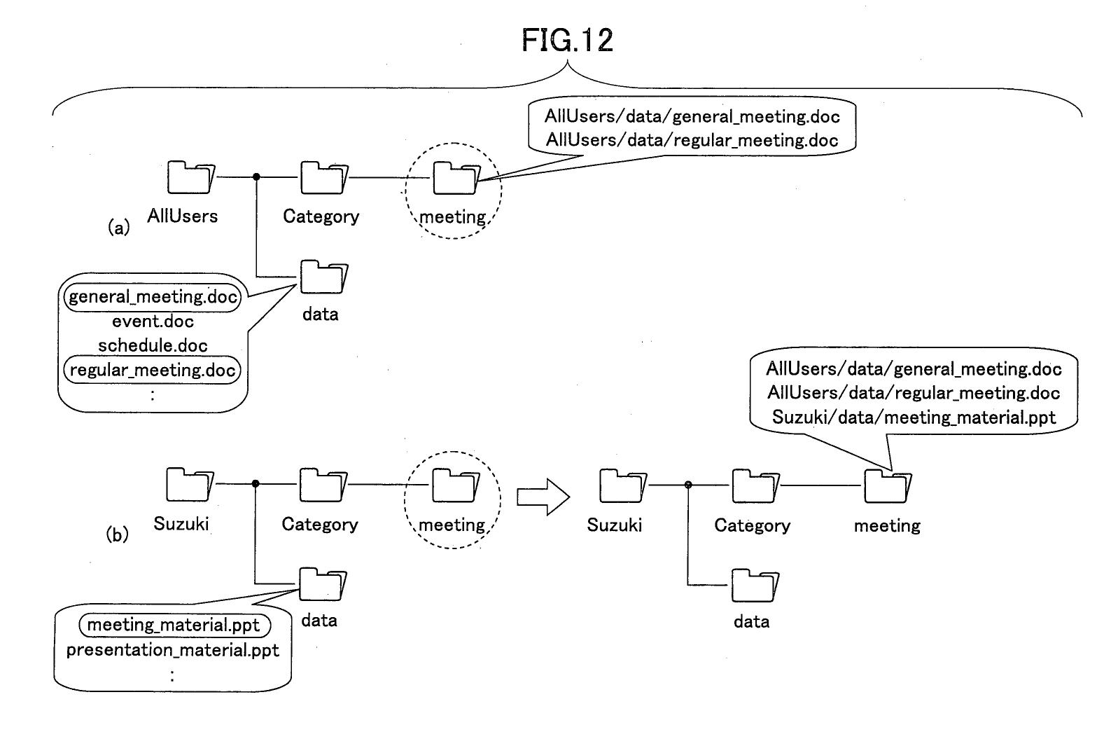

FIG. 12 is a diagram for explaining a search/arrange operation of the document managing device 100 of the present embodiment. In a state (a) of FIG. 12, a user creates a “meeting” folder at a lower-rank location of the AllUsers/category folder. In this case, the user uses the word “meeting” (the folder name of the created folder) as a search condition for searching electronic data. The categorizing unit 18 first detects an upper-rank folder of the “meeting” folder created by the user as being the AllUsers/category folder.

Accessing the folder management information 21, the categorizing unit 18 confirms a searching range of the AllUsers/category folder, and searches for the folder indicated by the searching range. Because the data files with the file name containing the word “meeting” are in the AllUsers/data folder, the data managing unit 13 creates the link information to the hit data files “general_meeting.doc” and “regular_meeting.doc”. Therefore, the link information “AllUsers/data/general_meeting.doc, AllUsers/data/regular_meeting.doc” is stored in the meeting folder by the data managing unit 13.

The user may also create a folder at a lower-rank location of the AllUsers/data folder. However, in this case, the AllUsers/data folder is a data file storage folder, and the data managing unit 13 registers the folder in the folder management information 21 as a data file storage folder. Therefore, the folder name of this folder does not become a search key, and this folder becomes a searching object.

In a state (b) of FIG. 12, the user further creates a meeting folder at a lower-rank location of the Suzuki/category folder in the state (a) of FIG. 12. In the state (b) of FIG. 12, the illustration of the folders on the side of the AllUsers folder (shared folder) is omitted. The categorizing unit 18 first detects an upper-rank folder of the meeting folder.

Accessing the folder management information 21, the categorizing unit 18 confirms a searching range of the Suzuki/category folder and searches for the folders indicated by the searching range. In this case, the Suzuki folder is a user folder, and the searching range of the Suzuki/category folder includes the AllUsers/data folder and the Suzuki/data folder.

The data managing unit 13 creates the link information for the hit data files “meeting_material.ppt”, “general_meeting.doc” and “regular_meeting.doc”. Hence, the link information “Suzuki/data/meeting_material.ppt, AllUsers/data/general_meeting.doc, AllUsers/data/regular_meeting.doc” is stored in the Suzuki/category/meeting folder by the data managing unit 13.

In this manner, various data files can be searched for with different search conditions one after another, without changing the previous search results.

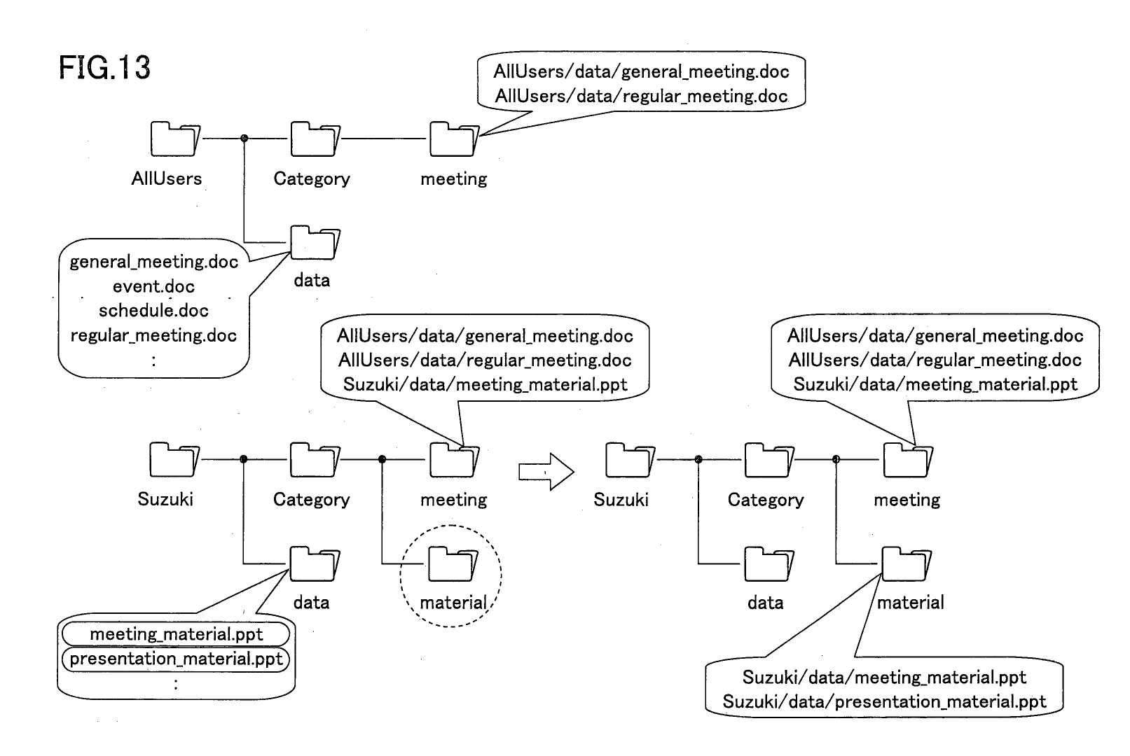

FIG. 13 shows a search/arrange operation of the document managing device 100 when the user further creates a material folder at a lower-rank location of the Suzuki/category folder in the state (b) of FIG. 12. The categorizing unit 18 first detects an upper-rank folder of the material folder. The upper-rank folder (Suzuki/category folder) of the material folder is the same as in the state (b) of FIG. 12.

Accessing the folder management information 21, categorizing unit 18 confirms a searching range of the Suzuki/category folder and searches for the folders indicated by the searching range. The searching range in this case includes the AllUsers/data folder and the Suzuki/data folder. The data managing unit 13 creates the link information to the hit data files “meeting_material.ppt” and “presentation_material.ppt”. Hence, the link information “Suzuki/data/meeting_material.ppt, Suzuki/data/presentation_material.ppt” is stored in the Suzuki/category/data folder by the data managing unit 13.

Because the search results (link information) are distinguished by a folder even when the previous search results remain unchanged, it is possible that plural folders have the same link information. Hence, it is conceivable that the data file “meeting_material.ppt” is hit with respect to two keywords “meeting” and “material”.

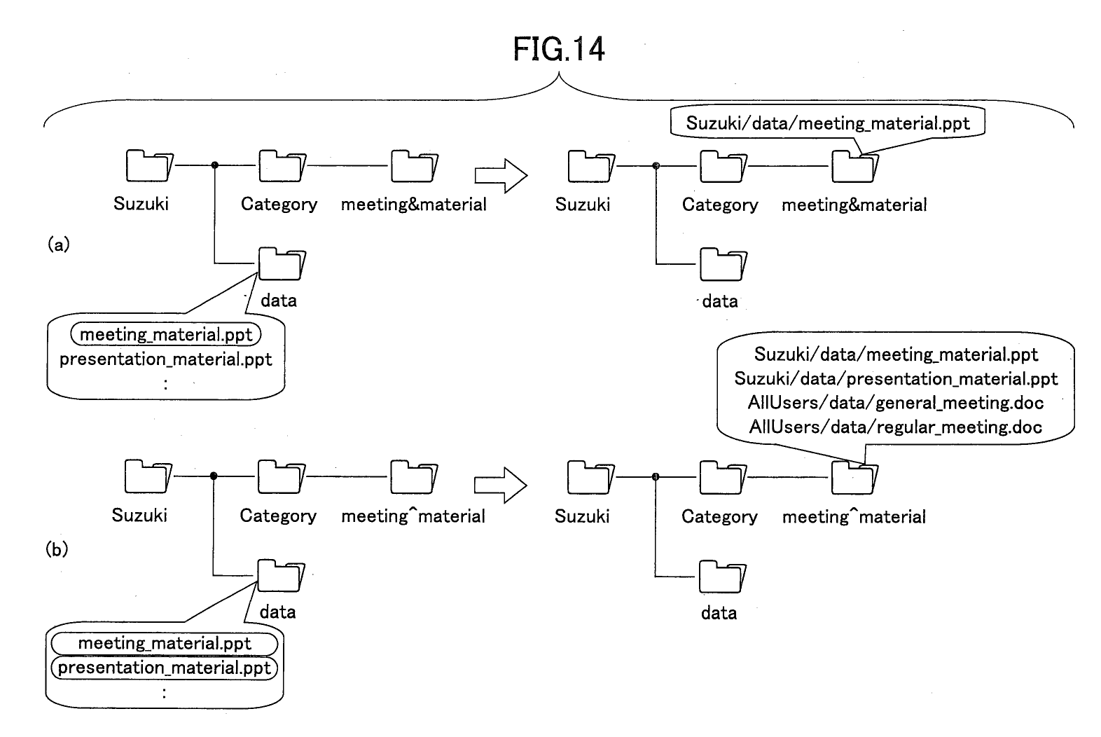

A search/arrange operation using such two keywords can also be performed by the document managing device 100 by creating a single folder. FIG. 14 shows a search/arrange operation of the document managing device 100 in which a user searches for a data file using two keywords. When the user desires to search for a data file which is hit with respect to the two keywords “meeting” and “material”, the user inputs a folder name according to the folder naming rules. For example, in the folder naming rules of the present embodiment, it is defined that a search symbol “&” represents an AND and a search symbol “̂” represents an OR.

Hence, when the user desires to search for a data file by using the two keywords “meeting” and “material”, the user inputs “meeting&material” as the folder name of the link information storage folder. When a meeting& material folder is created at a lower-rank location of the Suzuki/category folder, the categorizing unit 18 first detects an upper-rank folder of the material folder. The upper-rank folder (Suzuki/category folder) of the material folder is the same as in the state (b) of FIG. 12.

Accessing the folder management information 21, the categorizing unit 18 confirms a searching range of the Suzuki/category folder and searches the folders indicated by the searching range. The searching range in this case includes the AllUsers/data folder and the Suzuki/data folder.

The categorizing unit 18 is configured to conduct a search depending on whether a search symbol is included in the folder name. Hence, using both “meeting” and “material” of the meeting&material folder as keywords, the categorizing unit 19 searches for a data file. Similarly, the data managing unit 13 creates the link information to the hit data file “meeting_material.ppt”. Hence, as in the state (a) of FIG. 14, the link information “Suzuki/data/meeting_material.ppt” is stored in the Suzuki/category/meeting& data folder.

When the user inputs “meetinĝmaterial” as the folder name, using either “meeting” or “material” as the search keyword, the categorizing unit 19 searches data files. In this case, as in a state (b) of FIG. 14, the link information “Suzuki/data/meeting_material.ppt, Suzuki/data/presentation_material.ppt. AllUsers/data/general_meeting.doc, AllUsers/data/regular_meeting.doc” is stored in a Suzuki/category/meetinĝdata folder.

As described above, the document managing device 100 of this embodiment can search for and arrange data files with simple operations. Because the previous searching/arranging results remain unchanged, accessing and using such results, rearrangement of the data files in the folder structure and addition of search conditions can be carried out with simple operations.

### Embodiment 2

In the present embodiment, the document managing device 100 is configured to include a function to search for and arrange data files in a hierarchic folder structure by using the searching and arrangement function of the document managing device 100 of the Embodiment 1.

For example, there is a case in which a user desires to narrow down the data files (the links to the data files) obtained by conducting a search with a keyword “meeting”. When many data files are obtained, such demands will increase. In such a case, the document managing device 100 of this embodiment narrows down the search results by using a folder name of a link information storage folder newly created at a lower-rank location of a link information storage folder.

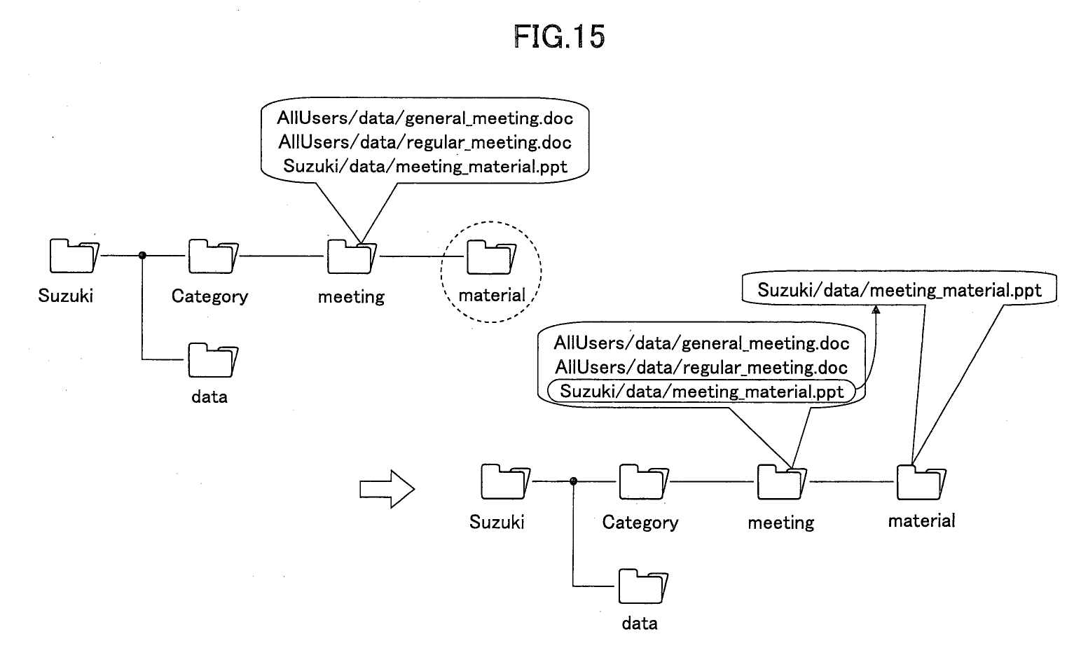

FIG. 15 is a diagram for explaining an arranging operation of the document managing device of the present embodiment to arrange data files in a hierarchical folder structure. In FIG. 15, the illustration of folders on the side of the AllUsers folder is omitted. It is assumed that a user already creates a meeting folder at a lower-rank location of the Suzuki/category folder. At this time, the link information “AllUsers/data/general_meeting.doc, AllUsers/data/regular_meeting.doc, Suzuki/data/meeting_material.ppt” is stored in the meeting folder.

When the user creates a material folder at a lower-rank location of the Suzuki/category/meeting folder, the categorizing unit 18 conducts a search by setting only the data files, which are indicated by the link information of the meeting folder, to the searching object and using the folder name “material” as the keyword. In this manner, the search results obtained by searching for the data files by using the keyword “meeting” can be narrowed down by searching for the data files by using the folder name “material”. The link information of the meeting folder is registered in the folder management information 21 in advance.

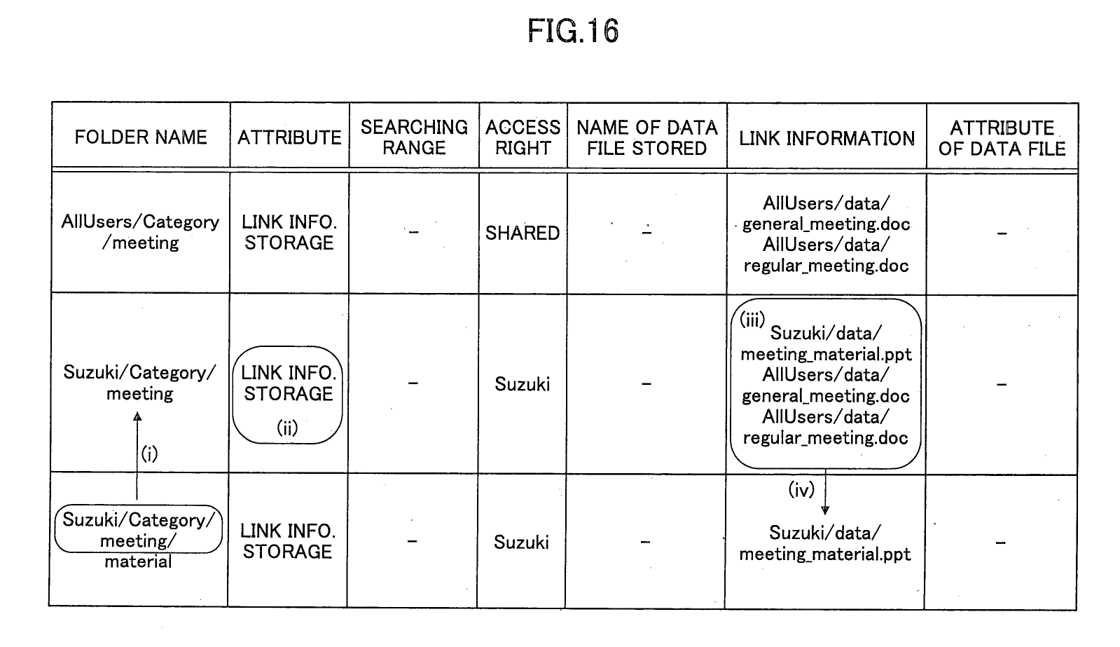

FIG. 16 is a diagram showing an example of the folder management information 21 of this embodiment. In FIG. 16, only the folder management information with respect to the link information storage folders is extracted. With reference to FIG. 16, the arranging operation performed by the document managing device 100 of this embodiment will be described.

(i) The categorizing unit 18 first detects an upper-rank folder (Suzuki/category/meeting folder) of the material folder.
(ii) Accessing the folder management information 21, the categorizing unit 18 confirms that the Suzuki/category/meeting folder is not a searching/arranging folder but a link information storage folder.
(iii) When the Suzuki/category/meeting folder is not a searching/arranging folder, the categorizing unit 18 reads the link information of the upper-rank folder (the Suzuki/category/meeting folder) in the folder management information 21. On the other hand, when the Suzuki/category/meeting folder is a searching/arranging folder, the categorizing unit 18 conducts a search as in the Embodiment 1.
(iv) The categorizing unit 18 searches for the data files indicated by the read link information of the upper-rank folder by using the folder name of the newly created folder (the material folder). In this way, by reading the link information of the upper-rank folder, the data files are searched for. It is possible to perform the search in a short time.

As shown in FIG. 15, the data managing unit 13 creates the link information to the hit data file “meeting_material.ppt” similar to the Embodiment 1. Hence, the link information “Suzuki/data/meeting_material.ppt” is stored in the Suzuki/category/meeting/material folder.

As described in the Embodiment 1, the previous search results remain unchanged and the search results are always updated by the document processing device of this embodiment. Hence, the document processing device of this embodiment is configured to perform a hierarchical search/arrange operation using the previous search results.

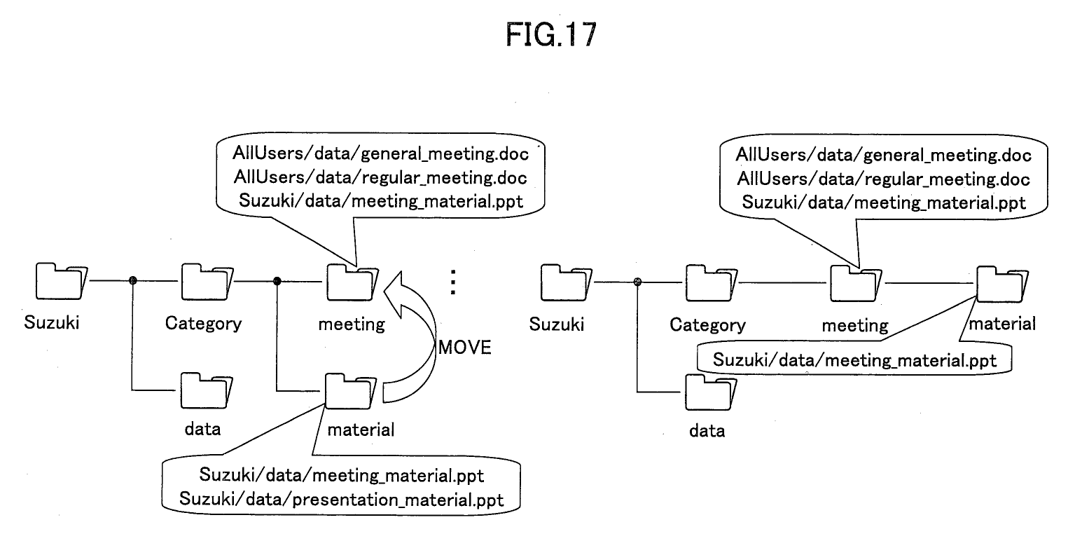

FIG. 17 is a diagram for explaining a hierarchical search/arrange operation by a combination of folders. In FIG. 17, the illustration of folders on the side of the AllUsers folder is omitted. It is assumed that a user already creates a meeting folder and a material folder at lower-rank locations of the Suzuki/category folder. At this time, the link information “AllUsers/data/general_meeting.doc, AllUsers/data/regular_meeting.doc, Suzuki/data/meeting_material.ppt” is stored in the meeting folder, and the link information “Suzuki/data/meeting_material.ppt, Suzuki/data/presentation_material.ppt” is stored in the material folder.

If the user desires to narrow down the search results of the meeting folder by using “material” as a keyword, the user moves the material folder to a lower-rank location of the meeting folder (or the material folder is moved into the meeting folder). The categorizing unit 18 is configured to search for the data files which are indicated by the link information of the meeting folder, similar to the case where the material folder is newly created.

In this case, the contents of the folder management information 21 before the hierarchical search/arrange operation are changed by deleting the record of the Suzuki/category/material folder and newly creating a record of the Suzuki/category/meeting/material folder. Namely, the contents of the folder management information 21 after the hierarchical search/arrange operation are the same as those of FIG. 16. Therefore, the document managing device 100 of this embodiment can perform the search/arrange operation using the previous search results if the user performs a simple operation to move a folder.

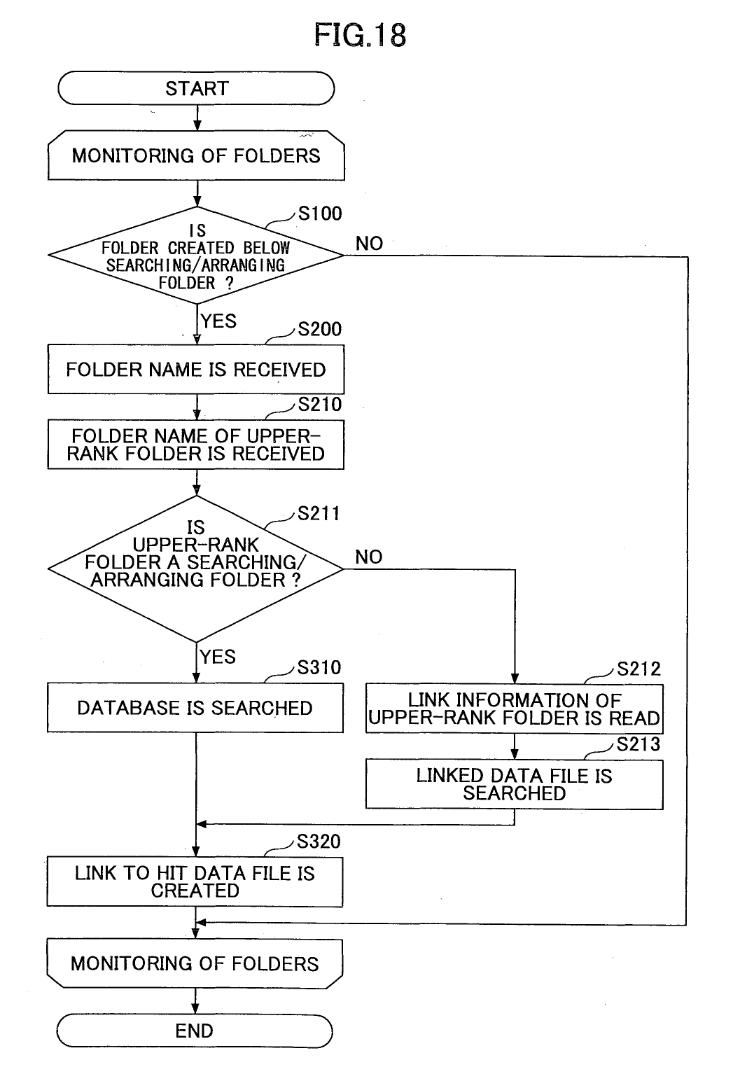

FIG. 18 is a flowchart for explaining a search/arrange process in which the document managing device 100 of this embodiment searches for and arranges a data file. Upon starting of the document managing device 100, the process of FIG. 18 is started.

The category folder monitoring unit 16 monitors the category folders. Based on the monitored result, the category folder monitoring unit 16 determines whether a folder is created at a lower-rank location of a searching/arranging folder (S100).

In this embodiment, the creation of a folder includes creation of a folder by moving the folder.

When it is determined at the step S100 that the folder is created at the lower-rank location of the searching/arranging folder, the categorizing unit 18 receives a folder name of the created folder from the category folder monitoring unit 16 (S200).

Subsequently, the categorizing unit 18 detects a folder name of the upper-rank folder of the created folder (S210). The categorizing unit 18 determines whether the upper-rank folder is a searching and arranging folder, by accessing the folder management information 21 (S211).

When it is determined at the step 211 that the upper-rank folder is a searching and arranging folder, the categorizing unit 18 searches the database 20 using the folder name of the created folder. Specifically, using the folder name as a keyword, the categorizing unit 18 performs the search/arrange process on the data file storage folder (S310).

The data managing unit 13 creates the link information with respect to the hit data files, and stores the link information in the link information storage folder (S320).

When it is determined at the step S211 that the upper-rank folder is not a searching and arranging folder, the upper-rank folder is a link information storage folder. The categorizing unit 18 reads the link information of the upper-rank folder of the created folder (S212).

Subsequently, the categorizing unit 18 sets only the data files indicated by the read link information to the searching object and conducts a search by using the folder name of the created folder as a keyword (S213).

After the step 310 or the step S213 is performed, the categorizing unit 18 creates the link information with respect to the hit data files and stores the created link information in the link information storage folder (S320).

When it is determined at the step S100 that no folder is created at the lower-rank location of the searching/arranging folder, the control of the document managing device 100 is returned to the monitoring of the category folders. Upon power-down of the document managing device 100, the process of FIG. 18 is terminated.

As described above, the document managing device 100 of this embodiment uses the previous search results in the link information storage folder and can search for and arrange data files. If the folder hierarchical folder structure is created, the data files can be searched for and arranged with simple operations. When the previously created folder name is used as a keyword, the document managing device 100 of this embodiment can perform the search/arrange operation if the user performs a simple operation to move a folder.

### Embodiment 3

In the Embodiments 1 and 2, the data files are searched for by using the folder name as the keyword. In the present embodiment, the document managing device 100 is configured to search for the data files by applying a search option to the folder name.

For example, by using the search option, data files that are created in a particular time period or on a particular date, or data files that have a particular file size can be searched for. With the document managing device 100 of the present embodiment, a user is allowed to select one of the following search options applied to the folder name, and the categorizing unit 18 detects a selected search option based on the folder name input by the user.

“date”+“-”+“date”: the searching object is a data file the date of creation of which is contained in the time period indicated by this search option, instead of using the folder name itself. For example, if the input folder name is set to “20120101-20121231”, data files the dates of creation of which are included in the time period from Jan. 1, 2012 to Dec. 31, 2012 will be searched for. If the input folder name is set to “20120101-20120101”, data files which are created on Jan. 1, 2012 will be searched for.

“˜”+“date”: the searching object is a data file the date of creation of which precedes the date indicated by this search option, instead of using the folder name itself. For example, if the input folder name is set to “˜20121231”, data files the dates of creation of which precede Dec. 31, 2012 will be searched for.

“date”+“˜”: the searching object is a data file the date of creation of which follows the date indicated by this search option, instead of using the folder name itself. For example, if the input folder name is set to “20120101˜”, data files the dates of creation of which follow Jan. 1, 2012 will be searched for.

“size”+“numeric_value”+“-”+“numeric_value”: the searching object is a data file having a file size indicated by this search option, instead of using the folder name itself. Data files having file sizes in the range indicated by the two numeric values (Kbytes) of this search option will be searched for. For example, if the input folder name is set to “size100-300”, data files having file sizes in the range of 100 to 300 Kbytes will be searched for. Similar to the time period option, “˜” may be used for this option.

Furthermore, the following search option may also be used.

“★”+“date”+“-”+“date”: the creation date of the data file instead of a folder name is used to search for the data files contained in the period. For example, if the input folder name is set to “★20120101-20121231”, data files the dates of creation of which are included in the time period from Jan. 1, 2012 to Dec. 31 will be searched for.

The categorizing unit 18 receives an input folder name and determines whether a search option is contained in the folder name. If the search option is contained in the folder name, the data files are searched for by using the time period or the file size indicated by the search option. If no search option is contained in the folder name, the data files are searched for as in the Embodiments 1 and 2 described above.

A search/arrange process performed by the document managing device of this embodiment is essentially the same as that of the Embodiment 2, and therefore the illustration of a flowchart of this embodiment will be omitted. The search/arrange process performed by the document managing device of this embodiment will be described in the following. In the following, the steps which are the same as corresponding steps of the search/arrange process shown in FIG. 18 are designated by the same reference numerals, and a description thereof will be omitted.

When it is determined at the step S211 that the upper-rank folder is a searching and arranging folder, the categorizing unit 18 determines whether a search option is contained in the folder name (S310). If no search option is contained in the folder name, the categorizing unit 18 uses the folder name as a keyword and performs the search/arrange process on the data file storage folder (S310). If the search option is contained in the folder name, the categorizing unit 18 uses the time period or the file size indicated by the search option as a keyword and performs the search/arrange process on the data file storage folder (S310).

On the other hand, when it is determined at the step S211 that the upper-rank folder is not a searching and arranging folder, the categorizing unit 18 determines whether a search option is contained in the folder name (S212). If no search option is contained in the folder name, the categorizing unit 18 reads the link information of the upper-rank folder of the created folder (S212), sets only the data files indicated by the link information to the searching object, and conducts a search by using the folder name of the created folder as a keyword (S213). If the search option is contained in the folder name, the categorizing unit 18 reads the link information of the upper-rank folder of the created folder (S212), sets only the data files indicated by the link information to the searching object, and conducts a search by using the time period or the file size indicated by the search option as a keyword (S213).

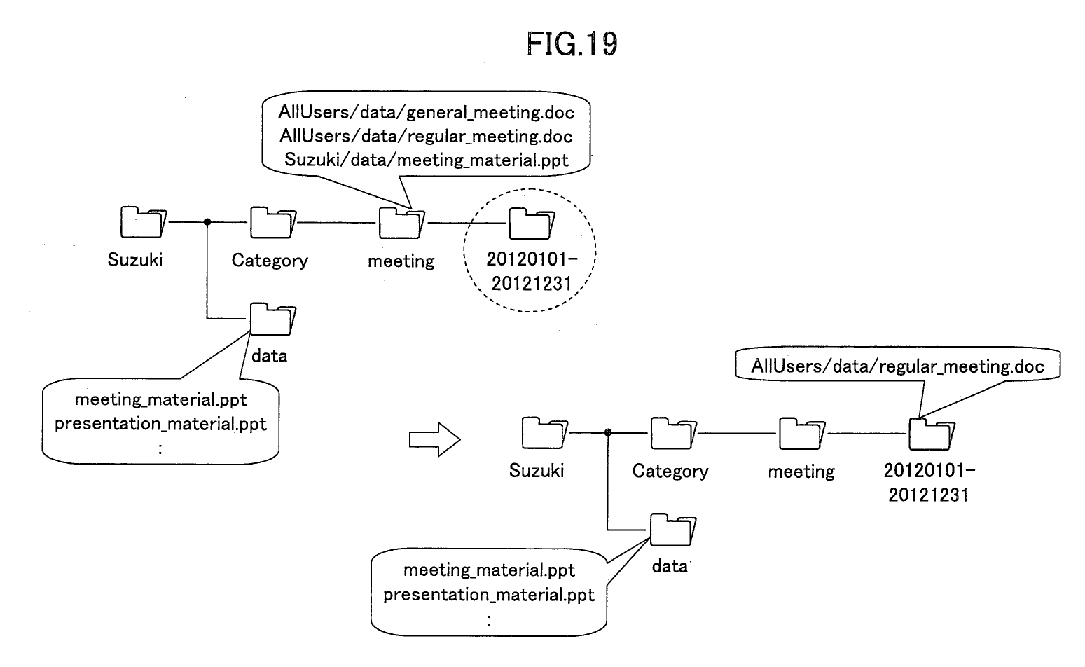

FIG. 19 shows a search/arrange operation of the document managing device 100 using a time period. It is assumed that the link information “Suzuki/data/meeting_material.ppt, AllUsers/data/general_meeting.doc, AllUsers/data/regular_meeting.doc” is already stored in the Suzuki/category/meeting folder.

In this state, the user creates a Suzuki/category/meeting/20120101-20121231 folder. The categorizing unit 18 detects the search option from the folder name of the created folder, and searches for data files, which are created within the time period of 20120101-20121231, among the data files indicated by the link information “Suzuki/data/meeting_material.ppt, AllUsers/data/general_meeting.doc, AllUsers/data/regular_meeting.doc” of the meeting folder. For example, when the data file “regular_meeting.doc” was created in February, 2012, the link information “AllUsers/data/regular_meeting.doc” is stored in the 20120101-20121231 folder.

In this manner, the data files can be searched for using a selected one of the various search options in this embodiment. A folder having a folder name that indicates the search option can be created as the lower-rank folder of the folder searched with the folder name, and the data files can be arranged in a more detailed way.

### Embodiment 4

In the present embodiment, the document managing device 100 is configured to display a search status during a search for data files. The searching time increases as the number of data files increases. It is preferred to display the search status for a user to grasp the degree of progress of the search operation.

The document managing device 100, of this embodiment creates a status file for providing a display indication indicating a search status and stores the status file in a link information storage folder.

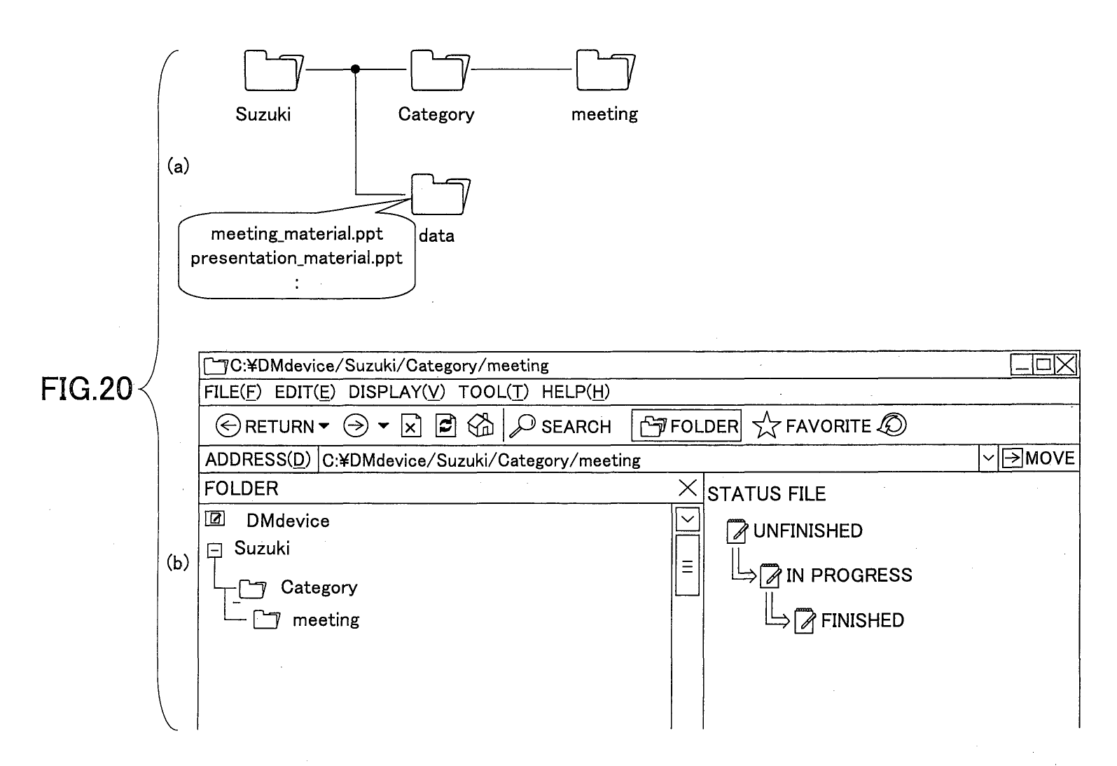

FIG. 20 is a diagram for explaining a display indication of a status file. In a state (a) of FIG. 20, a user creates a Suzuki/category/meeting folder. The categorizing unit 18 starts performing the categorizing process. When the number of data files stored in the Suzuki/data folder or the AllUsers/data folder at this time exceeds a threshold value, the categorizing unit 18 creates the status file in the link information storage folder. As shown in (b) of FIG. 20, the display indication of the status file changes with the passage of time as follows.

“unfinished”->“in progress”->“finished”

Because a user opens the link information storage folder to know the search results, the user can immediately find the display indication of the status file and can check the current state of the search operation with the transitional display indication of the status file. During a time period from the “unfinished” state to the “finished” state of the display indication of the status file, the link information is gradually stored in the link information storage folder.

The categorizing unit 18 may be configured to create the status file with a file name for providing a display indication indicating the number of link information items of the status file stored, in addition to the display indication indicating the search status. In this case, the number of the link information items of the status file increases with the passage of time. The number of link information items may simply be displayed. Alternatively, “a hit count/N” may be displayed where N denotes the total number of the data files as the searching objects.

The user can recognize that the search is in progress while viewing the display indication of the file name of the status file.

It is also effective to provide a display indication of the status file which represents a change of the search status by a change of color of a corresponding folder icon, instead of displaying the character-based status indication as shown in (b) of FIG. 20.

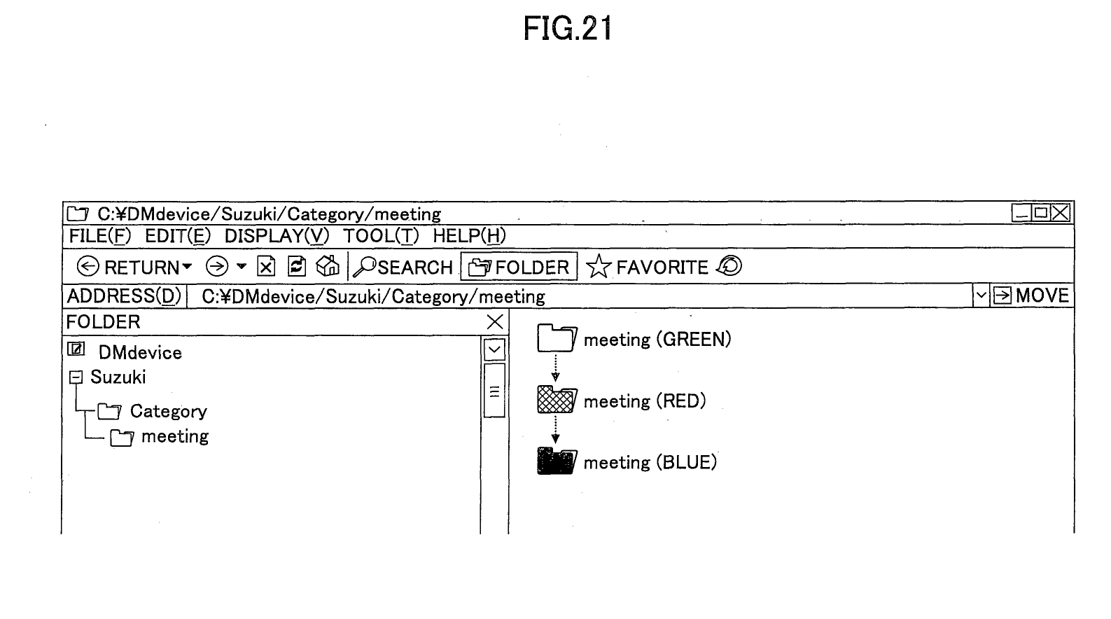

FIG. 21 is a diagram for explaining a display screen including a color-based display indication of a search status′. Similarly, it is assumed that the user creates the Suzuki/category/meeting folder within the Suzuki/category folder. In FIG. 21, a display indication (a corresponding folder icon) of an internal folder of the Suzuki/category folder is shown. For example, the categorizing unit 18 changes the color of the folder icon of the link information storage folder (meeting folder) according to the change of the search status, as follows.

“unfinished”: green

“in progress”: red

“finished”: blue

Such a process can be performed by preparing image data of folder icons with different colors and changing the image data of the folder icon displayed from one to another according to the change of the search status. Not only changing the color of the icon but also changing the shape of the icon according to the change of the search status is possible. Alternatively, blinking the folder icon according to the change of the search status is also possible.

When displaying the search status by using the status file as shown in (b) of FIG. 20, the user is required to open the corresponding folder (in this example, the meeting folder). In the example of FIG. 21, however, the user can grasp the search status by simply checking the color of the meeting folder while the upper-rank folder (in this example, the category folder) in which the meeting folder is created is opened.

The document managing device 100 of this embodiment can provide a user with the display indication of the status of the search/arrange process being performed by the file name or the folder icon color. Because a popup display indication of the file name within the folder is present by pointing to the folder icon with a mouse without opening the folder in the case of the OS, such as WINDOWS®, the user can easily grasp the search status or the number of link information items.

### Embodiment 5

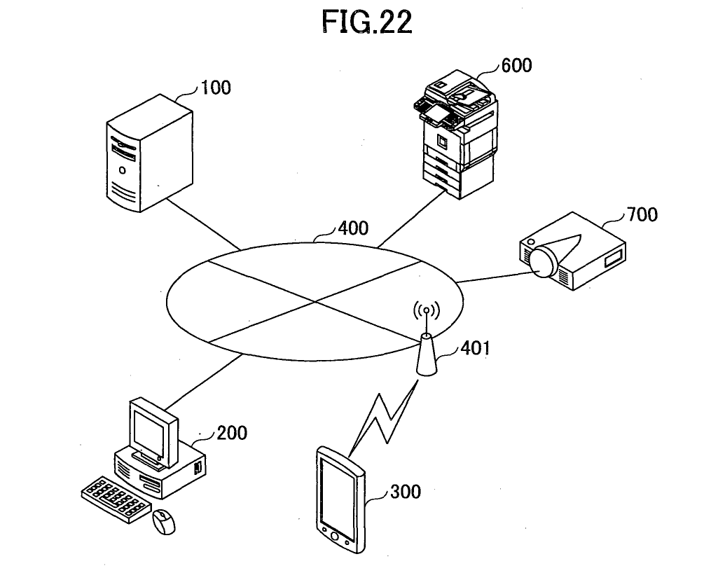

In the present embodiment, a case in which the link information as the search result is handled by an output device will be described. FIG. 22 is a diagram showing a network system including the document managing device 100 of this embodiment. In FIG. 22, the elements which are the same as corresponding elements in FIG. 2 are designated by the same reference numerals, and a description thereof will be omitted. In the network system of FIG. 22, an image forming device 600 and a projector 700 which are illustrated as examples of the output device are connected to the network 400.

Next, the image forming device 600 will be described as an example. For example, the image forming device 600 is constituted by an MFP (multi-function peripheral) or an LP (laser printer). Each of the image forming device 600, the mobile terminal 300 and the information processing apparatus 200 in the network system can access the link information as the result of the search/arrange process by the information processing device 100. For example, when the link information arranged in the document managing device 100 is accessed by one of the image forming device 600, the information processing apparatus 200 or the mobile terminal 300 using the SMB protocol, an original file (substance) of the link information can be opened and received.

However, when the link information arranged in the document managing device 100 is accessed by one of the image forming device 600, the information processing apparatus 200 or the mobile terminal 300 by using the HTTP or HTTPS protocol, the original file of the link information cannot be received even if the link information can be viewed. In the document managing device 100, in order to prevent the cache storage of files of the document managing device 100 in a WWW browser, “Cache-Control: no-cache” (which is provided to inhibit cache storage) is described in the header of an HTML file in the HTTP or HTTPS protocol. In the WWW browser, if the header of the received HTML file includes such description, the original file of the link information cannot be downloaded. Therefore, it is difficult to receive the original file in the case of the communications protocol or the WWW browser.

If the original file cannot be downloaded, the image forming device 600 cannot print the content of the link information or the projector 700 cannot display the content of the link information.

To eliminate the problem, the document managing device 100 of this embodiment is configured to allow one of the image forming device 600, the information processing apparatus 200 or the mobile terminal 300 to receive the original file of the link information, even when the link information arranged in the document managing device 100 is accessed by using the HTTP or HTTPS protocol.

Specifically, when the image forming device 600 accesses the link information by the HTTP or HTTPS protocol, the document managing device 100 returns the original file to the image forming device 600. The same operation can be performed also when the information processing apparatus 200 or the mobile terminal 300 accesses the link information in the document managing device 100.

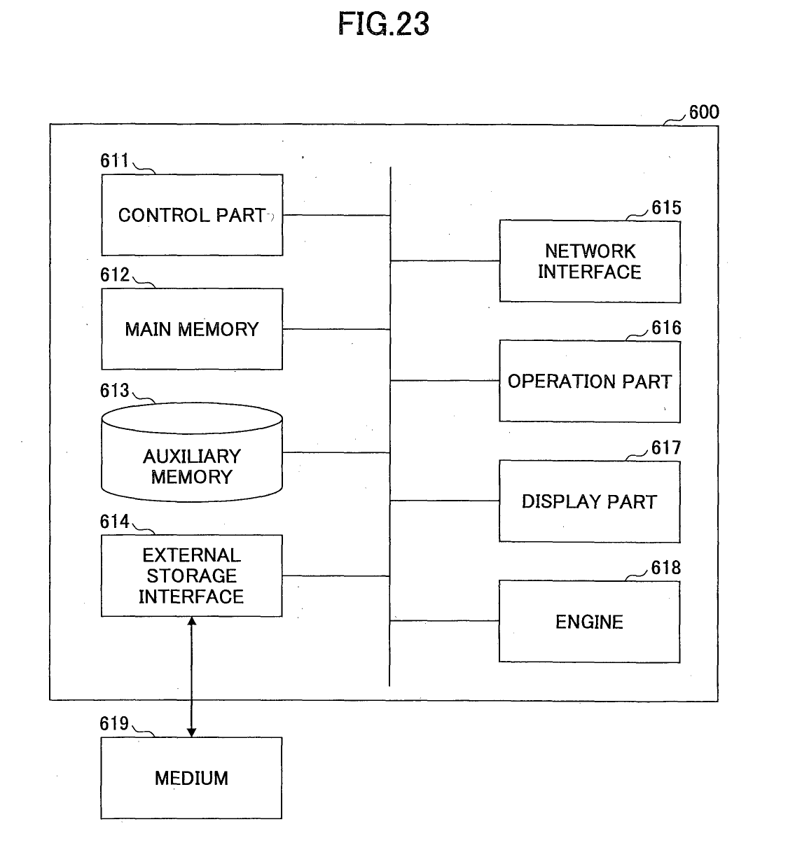

FIG. 23 shows the hardware composition of an image forming device. The image forming device 600 is well known in the art and the hardware composition thereof is exemplary and explanatory.

As shown in FIG. 23, the image forming device 600 includes a control part 611, a main memory 612, an auxiliary memory 613, an external storage interface 614, a network interface 615, an operation part 616, a display part 617, and an engine 618. These elements are interconnected by a bus so that data transmission and reception between the elements is possible.

The control part 611 performs control of the respective parts of the image forming device, and performs computation and processing of data. For example, the control part 611 is formed by a CPU. The control part 611 is a processor unit which executes the program stored in the main memory 612 or the auxiliary memory 613, and the processor unit receives data from an input device or a storage device and performs computation and processing of the data, so that the resulting data is output to an output unit or a storage device.

The main memory 612 is, for example, a RAM (random access memory). The main memory 612 stores or temporarily stores the OS and application programs which are executed by the control part 611, data relevant to the application programs, etc. The auxiliary memory 613 is, for example, an HDD (hard disk drive). The auxiliary memory 613 stores the data relevant to application programs, etc.

The external storage interface 614 is an interface which transmits and receives data according to the data transmission line and data communication standard, such as USB (universal serial bus). For example, a recording medium 619, such as a flash memory or an SD card, is attached and connected to the external storage interface 614.

The network interface 615 is an interface which is provided in the image forming device 600 to communicate with the document managing device via a network formed by wired or wireless data transmission lines, such as LAN (local area network) or WAN (wide area network).

The operation part 616 and the display part 617 include key switches (hard keys) and a liquid-crystal display (LCD) with a touch-panel function (including software keys of GUI (graphical user interface)). A menu screen is displayed on the display part 617 and a user's operation is received from the operation part 616.

The engine 618 prints image data on a printing sheet by means of an electrophotographic printing process or an inkjet printing process. The engine 618 may include not only a printing engine but also a scanning engine for optically reading a paper document to generate image data.

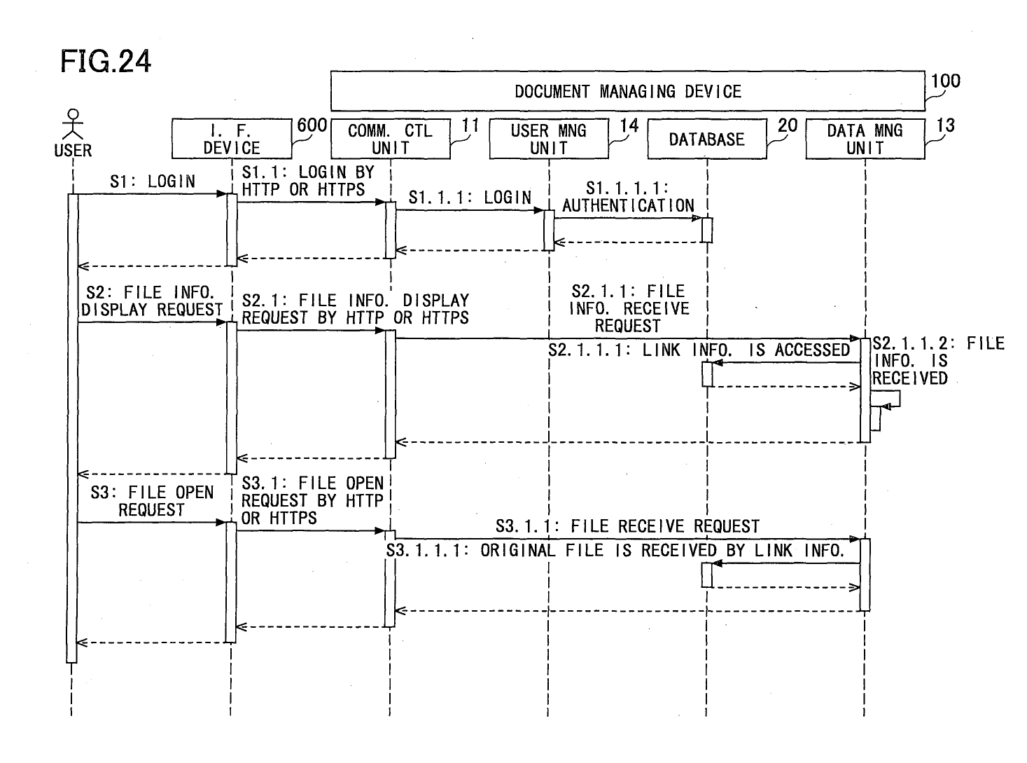

FIG. 24 is a sequence diagram for explaining a file receiving process in which the image forming device 600 receives the original file from the document managing device 100. It is assumed that a user manipulates the operation part 616 of the image forming device 600 and accesses the information managing device 100 by using the HTTP or HTTPS protocol. As shown in FIG. 24, the file receiving process is performed by the image forming device 600 and the document managing device 100 as follows.

In step S1, the user logs into the image forming device 600. Upon the login, a user ID (or user name) and a password are entered into the image forming device 600.

In step S1.1, the image forming device 600 transmits a log-in request and the user information to the document managing device 100 by using the HTTP or HTTPS protocol.

In step S1.1.1, the document managing device 100 causes the communication control unit 11 to receive the request and pass the user information to the user managing unit 14 as login information.

In step S1.1.1.1, the user managing unit 14 determines whether the received user information matches the user information currently stored in the database 20 and determines whether the user is authenticated correctly. Here, it is assumed that the user is authenticated correctly. The user managing unit 14 transmits an authentication accept response to the image forming device 600 via the communication control unit 11.

Upon the login, the document managing device transmits the link information which is the result of the search/arrange process to the image forming device 600 automatically or in response to receiving an explicit request from the image forming device 600.

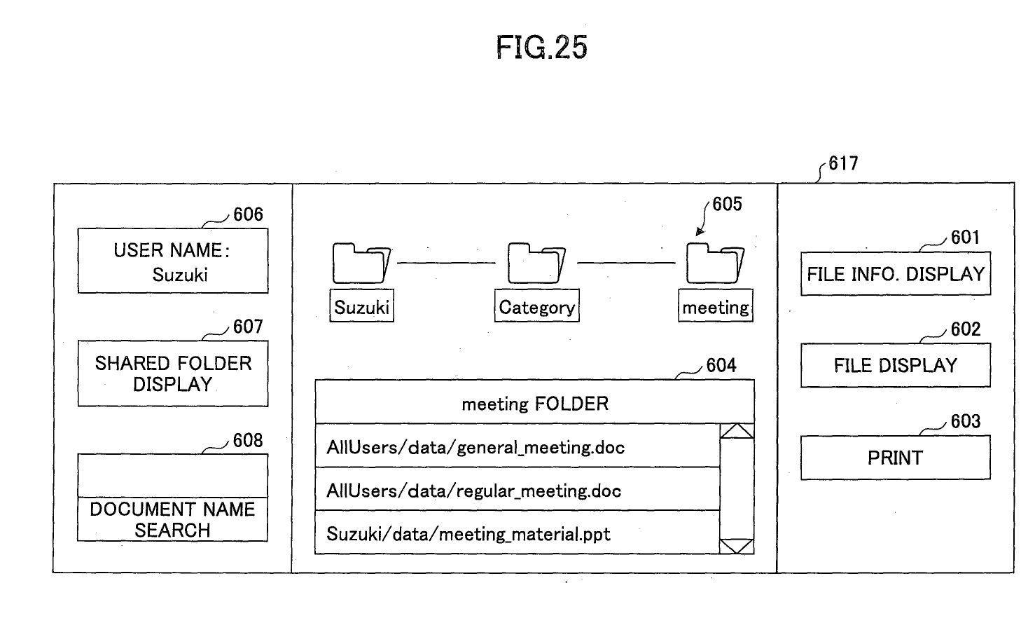

FIG. 25 is a diagram showing an example of the link information displayed on the display part 617 of the image forming device 600. On the left-hand side of the display screen on the display part 617, a user name 606 “Suzuki” of the user who has logged in, a “shared folder display” button 607, and a document name search button 608 are displayed.

In the middle of the display screen, a display indication of the link information is displayed. When the “meeting” folder is created in the document managing device 100, the “meeting” folder in which the link information is contained is transmitted from the document managing device 100 to the image forming device 600. If the user presses and selects the meeting folder containing the search results, the link information is displayed. In the example of FIG. 25, a hierarchical folder structure 605 and link information items 604 of the meeting folder are displayed.

On the right-hand side of the display screen, a “file information display” button 601, a “file display” button 602, and a “print” button 603 are displayed. The user can select one or more of the link information items in the meeting folder and can press one of these buttons. If the “file information display” button 601 is selected and pressed, the processing of step S2 of FIG. 24 is performed. If the “file display” button 602 is selected and pressed, the processing of S3 of FIG. 24 is performed. If the “print” button 603 is selected and pressed, a corresponding file is printed. The sequence of selecting these buttons is arbitrary.

Referring back to FIG. 24, the file receiving process will be described.

In step S2, the user performs an operation on the image forming device 600 for sending a file information display request to the document managing device 100 in order to display the file information indicated by the link information stored in the document managing device 100. The link information is held in the image forming device 600 but the original file of the link information is not held. One or more link information items are selected from the meeting folder displayed on the image forming device 600 as shown in FIG. 25, and the file information display request is transmitted to the document managing device 100.

In step S2.1, the image forming device 600 specifies the folder path and sends the file information display request to the document managing device 100 by using the HTTP or HTTPS protocol. The communication control unit 11 determines whether the request is received by using the HTTP or HTTPS protocol. Only when the request is received by using the HTTP or HTTPS protocol, the subsequent steps are performed. The reception of the request by the HTTP or HTTPS protocol is determined by the port number (80 in case of HTTP, and 443 in case of HTTPS) of the TCP header. In a case of another protocol which is different from the HTTP or HTTPS protocol and does not allow downloading of the original file of the file information, a similar process may be performed.

For example, the file information includes a file size, a date of creation, a date of updating, a writer, a file type, etc. The document managing device 100 causes the communication control unit 11 to receive the file information display request from the image forming device 600.

In step S2.1.1, the communication control unit 11 sends a file information receive request to the data managing unit 13.

In step S2.1.1.1, the data managing unit 13 searches the location of the database 20 (in which the file information is stored) indicated by the link information in order to receive the file information of the original file from the link information.

In step S2.1.1.2, the data managing unit 13 receives the necessary file information from the location of the original file received from the database 20. The data managing unit 13 transmits the received file information to the image forming device 600 via the communication control unit 11.

In step S3, the user opens the file which is indicated by the link information stored in the document managing device 100. Generally, file opening is to enable the accessing of the file. In the present embodiment, file opening means receiving the original file or displaying the text of the original file.

Because the link information and the file information are stored in the image forming device 600, it is necessary to receive the original file in the document managing device 100 based on the link information of the image forming device 600.

In step S3.1, the image forming device 600 sends an original file request to the document managing device 100 by using the HTTP or HTTPS protocol. The communication control unit 11 of the document managing device receives the original file request by using the HTTP or HTTPS protocol. The communication control unit 11 determines whether the request is received by the HTTP or HTTPS protocol. Only when the request is received by the HTTP or HTTPS protocol, the subsequent processes are performed.

In step S3.1.1, the communication control unit 11 transmits an original file receive request to the data managing unit 13 in which the associations of the link information and the original file are managed.

In step S3.1.1.1, the data managing unit 13 receives the original file based on the link information. The data managing unit 13 transmits the received original file to the image forming device 600 via the communication control unit 11. The data managing unit 13 may perform format conversion before transmission. For example, if a format of a file of Microsoft Word® is converted into PCL (printer control language) format, printing of the link information is possible even if the image forming device 600 does not have a file open function of Microsoft Word®.

The image forming device 600 displays the link information of the received original file on the display part 617. Thereby, the user can receive the requested original file without recognizing that the data displayed on the image forming device 600 is the link information or the original file. When the displayed data is the link information and the reception of the original file is requested by using the HTTP or HTTPS protocol, the original file can be received through the above-described file receiving process. When the reception of the original file is requested by using the SMB protocol, the original file can be received by using the conventional method. When the original file is displayed on the display part 617, printing of the original file can be performed.

The same process can be performed also when the information processing apparatus 200 or the mobile terminal 300 receives the original file by using the HTTP or HTTPS protocol. The information processing apparatus 200 or the mobile terminal 300 can transmit the received original file to the image forming device 600 in order to print the received original file.

Next, a case in which the information processing apparatus 200 or the mobile terminal 300 transmits a file to another user will be explained as a modification of the embodiment of FIG. 24. There is a case where a user desires to share with another user (user-B) the file searched for by the information processing apparatus 200 or the mobile terminal 300.

However, when only the link information which is the result of the search/arrange process is transmitted and the original file of the link information is not stored in a shared folder, the user-B cannot receive the original file. Further, even if the original file is stored in a shared folder, when the user-B is an external user who does not have the authority to access the document managing device 100, the user-B cannot receive the original file.

In the following, a network system 500 which is configured to transmit an e-mail including the original file attached from a user to an external user (user-B) will be described.

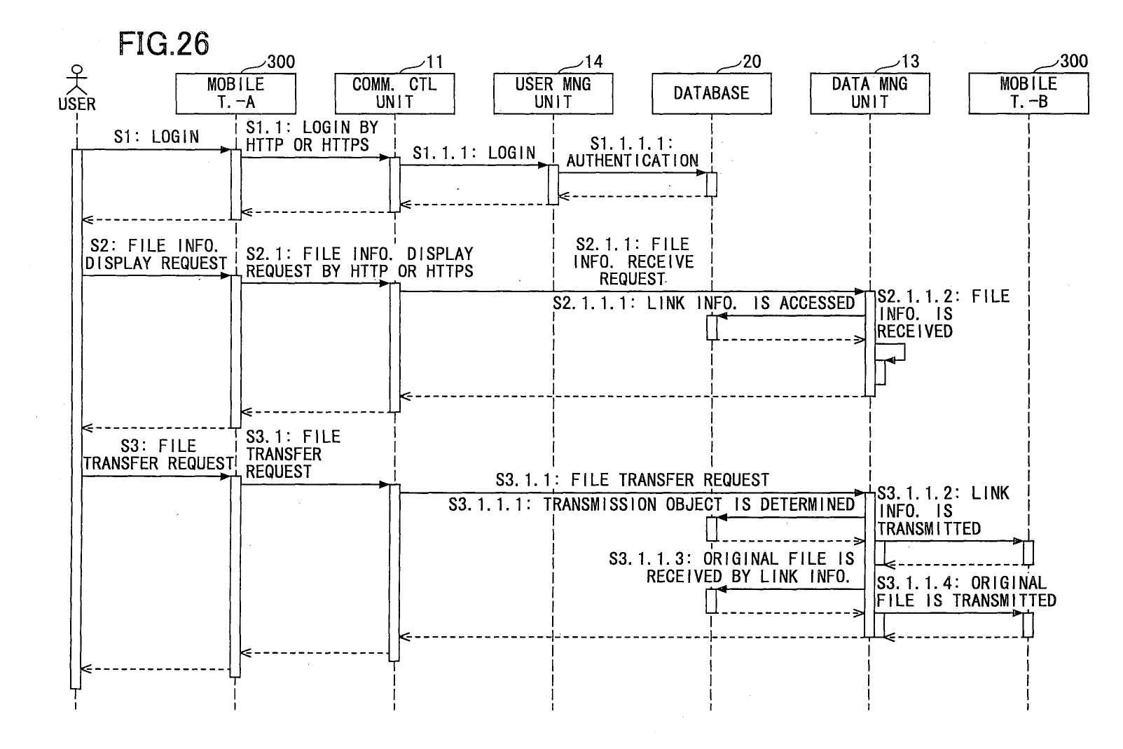

FIG. 26 is a sequence diagram for explaining a file receiving process in which the mobile terminal 300 receives the original file from the document managing device 100. In FIG. 26, the processing of steps S1-S2 is the same as the processing of corresponding steps of FIG. 24 and a description thereof will be omitted.

In step S3, the user of a mobile terminal-A who has checked the link information or the file information selects a file, designates the user-B as a destination and performs a file transfer operation, in order to transmit the file to a mobile terminal B of the user-B.

In step S3.1, the mobile terminal-A transmits a transfer request of the original file, including arguments of an e-mail address of the user B and the link information, to the document managing device 100 by using the HTTP or HTTPS protocol. The communication control unit 11 of the document managing device 100 receives the transfer request of the original file by using the HTTP or HTTPS protocol. The e-mail address of the user B is stored in the address book of the mobile terminal-A of the user or manually input by the user from a keyboard of the mobile terminal-A.

In step S3.1.1, the communication control unit 11 transmits the transfer request of the original file to the data managing unit 13.

In step S3.1.1.1, the data managing unit 13 determines which of the link information and the original file is to be transmitted, by accessing the database 20 in which the original file is stored. Specifically, it is determined whether the original file for which the transfer request is received can be accessed by the user-B. First, it is determined whether the domain portion of the e-mail address of the user-B is the same as the domain of the document managing device 100 or includes the domain of the document managing device 100. If a user has an access right to the document managing device 100, the domain portion of an e-mail address of the user is the same as the domain of the document managing device 100 and it can be determined that the user is an internal user. When the user-B is an internal user, it is determined whether the original file for which the transfer request is received is in a shared folder (a lower-rank folder of the AllUsers/category folder). When the user-B is an internal user and the original file is in a shared folder, the data managing unit 13 determines that the link information is to be transmitted. Otherwise the data managing unit 13 determines that the original file is to be transmitted.

In step S3.1.1.2, when it is determined that the link information is to be transmitted, the data managing unit 13 attaches the link information to an e-mail and transmits the e-mail to the mobile terminal B of the user B.

In step S3.1.1.3, when it is determined that the original file is to be transmitted, the data managing unit 13 receives the original file based on the link information.

In step S3.1.1.4, the data managing unit 13 attaches the original file to an e-mail and transmits the e-mail to the mobile terminal B of the user-B. When the communication control unit 11 has not received the request by the HTTP or HTTPS protocol, the data managing unit 13 transmits the link information to the mobile terminal B of the user-B, by assuming that the user-B accesses by another protocol different than the HTTP or HTTPS protocol.

Thus, the document managing device 100 transmits the original file when the user-B cannot access the original file, and the user can transmit the file to the user-B without recognizing that the file on the mobile terminal-A is the link information or the original file.

As described in the foregoing, according to the information processing device of the present invention, it is possible to arrange data items in folders with simple operations.

The information processing device of the present invention is not limited to the above embodiments, and numerous variations and modifications may be made without departing from the scope of the present invention.

The present application is based on and claims the benefit of the priority of Japanese Patent Application No. 2012-089359, filed on Apr. 10, 2012, and Japanese Patent Application No. 2013-048497, filed on Mar. 11, 2013, the entire contents of which are hereby incorporated by reference.

1. An information processing device including a processing unit, the processing unit comprising:
a storage area creation unit configured to create a storage area containing a search condition for searching for data items in response to an input operation;
a search unit configured to search for, when the storage area containing the search condition is created, data items which match the search condition contained in the storage area from among data items stored in a database;
a link information creation unit configured to create link information for accessing the matching data items searched for by the search unit; and
an arranging unit configured to arrange the link information created by the link information creation unit into the created storage area.

2. The information processing device according to claim 1, wherein the search condition contained in the storage area is a name of the storage area, and the search unit is configured to search for data items containing the name of the storage area.

3. The information processing device according to claim 1, wherein:
when a second storage area is created at a lower-rank location of the storage area containing the search condition, the search unit searches for data items which are indicated by the link information arranged in the storage area containing the search condition, based on a second search condition contained in the second storage area;
the link information creation unit creates link information for accessing the indicated data items searched for by the search unit; and
the arranging unit arranges in the second storage area the link information created by the link information creation unit.

4. The information processing device according to claim 1, wherein:
when the already created storage area containing the search condition is moved to a lower-rank location of the storage area containing the search condition, the search unit searches for data items which are to be indicated by link information arranged in an upper-rank storage area of the moved storage area, based on the search condition contained in the moved storage area;
the link information creation unit creates link information for accessing the indicated data items searched for by the search unit; and
the arranging unit arranges the link information created by the link information creation unit into the moved storage area.

5. The information processing device according to claim 1, wherein, when a predetermined search option in the search condition contained in the storage area is detected, the search unit sets an attribute value of data items indicated by the search option to a searching object, and searches for data items which match the search condition contained in the storage area.

6. The information processing device according to claim 1, wherein:
the database comprises user storage areas associated with user identifiers and storing data items of a user of each user identifier, and a shared storage area used in common by plural users and storing data items of each of the users; and
the processing unit comprises
a user information storage unit configured to store user information including user authentication information and the user identifiers; and
a user authentication unit configured to authenticate a user based on the user identifier and authentication information received from an external device; and
when the user authentication unit determines that the user is authenticated, the search unit determines a user storage area of the authenticated user and the shared storage area as being storage areas of searching objects.

7. The information processing device according to claim 1, wherein the processing unit further comprises:
a communication unit configured to receive the link information created by the link information creation unit from an external device by a predetermined communication protocol; and
a data transmission unit configured to transmit format-converted information of the data items indicated by the link information and obtained from the database to the external device.

8. The information processing device according to claim 1, wherein the processing unit further comprises:
a communication unit configured to receive the link information created by the link information creation unit from an external device by a predetermined communication protocol; and
a data transmission unit configured to transmit information containing data items indicated by the link information and obtained from the database to the external device.

9. The information processing device according to claim 1, wherein the processing unit further comprises:
a communication unit configured to receive the link information created by the link information creation unit, a data transfer request to transfer the link information to a destination, and destination information indicating the destination from an external device by a predetermined communication protocol; and
a data transmission unit configured to determine whether the data items indicated by the link information are accessible by a user of the destination, configured to transmit, when it is determined that the data items are accessible by the user of the destination, the link information to the destination, and configured to transmit, when it is determined that the data items are not accessible by the user of the destination, the data items indicated by the link information and obtained from the database to the destination.

10. An information processing method for an information processing device including a processing unit, the method comprising:
creating a storage area containing a search condition for searching for data items in response to an input operation;
searching for, when the storage area containing the search condition is created, data items which match the search condition contained in the storage area from among data, items stored in a database;
creating link information for accessing the matching data items searched for in the searching; and
arranging the link information created in the creating into the created storage area.

11. The information processing method according to claim 10, wherein the search condition contained in the storage area is a name of the storage area, and the searching comprises searching for data items containing the name of the storage area.

12. The information processing method according to claim 10, wherein:
the database comprises user storage areas associated with user identifiers and storing data items of a user of each user identifier, and a shared storage area used in common by plural users and storing data items of each of the users; and
the method further comprises
storing user information including user authentication information and the user identifiers; and
authenticating a user based on the user identifier and authentication information received from an external device; and
determining, when it is determined in the authenticating that the user is authenticated, a user storage area of the authenticated user and the shared storage area as being storage areas of searching objects.

13. The information processing method according to claim 10, further comprises:
receiving the link information created in the creating from an external device by a predetermined communication protocol; and
transmitting format-converted information of the data items indicated by the link information and obtained from the database to the external device.

14. The information processing method according to claim 10, further comprising:
receiving the link information created in the creating from an external device by a predetermined communication protocol; and
transmitting information containing data items indicated by the link information and obtained from the database to the external device.

15. The information processing method according to claim 10, further comprising:
receiving the link information created in the creating, a data transfer request to transfer the link information to a destination, and destination information indicating the destination from an external device by a predetermined communication protocol;
determining whether the data items indicated by the link information are accessible by a user of the destination;
transmitting, when it is determined that the data items are accessible by the user of the destination, the link information to the destination; and
transmitting, when it is determined that the data items are not accessible by the user of the destination, the data items indicated by the link information and obtained from the database to the destination.
